(19) United States
(12) Patent Application Publication
(10) Pub. No.: US 2026/0359018 A1
(43) Pub. Date: Nov. 12, 2026

(54) AUTOMATED AND SEMI-AUTOMATED PROGRAM CODE SYNTHESIS USING GENERATIVE MACHINE LEARNING COMPONENTS

(71) Applicant: Cogna Limited, London (GB)

(72) Inventors: Lars Robert Monica Mennen, London (GB); Benedict Peters, Hove (GB)

(21) Appl. No.: 19/515,333

(22) PCT Filed: Aug. 30, 2024
(86) PCT No.: PCT/EP2024/074359

§ 371 Date: Feb. 27, 2026

(30) Foreign Application Priority Data
Sep. 1, 2023 (GB) 2313395.2

(51) Int. Cl. G06F 8/35

(52) U.S. Cl. CPC G06F 8/35

(57) ABSTRACT

A machine learning (ML)-based generator is caused to generate an initial code artefact based by submitting at least one prompt to an ML-based generator. An error in the initial code artefact is identified by applying a static analysis to the initial indicating the identified error to the ML-based generator in at least one further prompt, causing the ML-based generator to generate an updated code artefact in response to the identified error.

### TECHNICAL FIELD

The present disclosure pertains to automated and semi-automated program code synthesis using generative machine learning (ML) components.

### BACKGROUND

In recent years, the field of software development has witnessed significant advancements with the integration of generative ML techniques for automating or assisting in the process of program code generation. These advancements have the potential to revolutionize software development by accelerating the creation of code, enhancing developer productivity, and facilitating the realization of complex functionalities. In particular, ‘large’ generative models (with typically a billion or more parameters) trained on vast datasets. Such models include so-called ‘large language models’ (LLMs), the largest of which have of the order of hundreds of billions of parameters, trained on essentially the entire public internet.

LLMs, such as GPT (Generative Pre-trained Transformer) variants, trained on massive amounts of training data, have demonstrated remarkable capabilities in understanding and generating human-like natural language text based on free-text prompts. However, the applications of such models extend far beyond natural language. Viewed more generally, such models take a sequence of data units as input (e.g., tokens of a text string, such as characters, words etc.) and output a sequence of data units in response. Neither sequence is constrained to have a fixed length. Increasing attention is being given to the use of such models to generate structured outputs that are ‘machine-readable’ in the conventional programmatic sense. Examples of such structured outputs include data structures conforming to a predefined data schema and program code conforming to a predefined programming syntax.

Researchers and developers have recognized the potential of these models for streamlining software development processes. By training these models on vast repositories of existing code, they can learn programming syntax, semantics, and patterns, enabling them to produce functional code snippets in response to natural language prompts or high-level descriptions of desired functionalities.

This approach holds promise for both automating routine coding tasks and providing developers with intelligent suggestions to guide their coding decisions. Developer time spent on repetitive and mundane tasks may be reduced. Moreover, this approach enables rapid prototyping and experimentation, allowing developers to iterate and refine their ideas more efficiently. This approach can also assist developers in learning new programming languages and paradigms by providing contextual examples and explanations. Such models can also potentially enhance the accessibility of software development, enabling individuals with limited coding experience to participate more effectively in the creation of software applications.

Despite the promise of large language models for code generation, there are several challenges and concerns that need to be addressed. While these models can produce syntactically correct code, ensuring semantic correctness, adherence to best practices, and absence of logical errors remains a challenge. The generated code may lack optimization and might not adhere to specific project requirements. Moreover, when prompted with a given task, large language models suffer from a lack of broader project context, making it difficult for them to produce code that aligns perfectly with the intended functionality and design goals. As such, code generated by LLMs might require extensive post-generation editing and maintenance, potentially negating some of the time-saving benefits initially gained. Existing LLM-based approaches also suffer from issues of explainability. Understanding how an LLM arrives at a specific code suggestion can be challenging, making it harder for developers to assess validity and debug code or program flows.

Structured output generation, such as code synthesis, may be facilitated by a practice known as prompt engineering, which plays a pivotal role in optimizing the interaction between developers/engineers and LLMs. Prompt engineering refers to the strategic construction of input prompts that effectively convey the desired task or instruction to a large language model. In the context of code synthesis, prompt engineering acts as a bridge between human-readable natural language prompts and the machine-understandable world of programming languages. It involves crafting prompts in a way that maximizes the model's ability to comprehend the programmer's intentions accurately and generate correct and contextually appropriate code snippets in response.

Crafting prompts with clarity and providing sufficient detail ensures that the LLM comprehends the specific requirements of the code to be generated and does not produce output that is merely plausible. For instance, instead of a vague prompt like “Write a function to sort data,” a more effective prompt could be “Create a Python function that takes a list of integers as input and returns the list sorted in ascending order.”

Including examples of desired inputs and corresponding outputs, as well as any necessary constraints, guides the LLM's understanding and aids in generating accurate code. For instance, alongside a prompt to generate a Fibonacci sequence, examples of the first few terms of the sequence can enhance the model's performance.

Utilizing appropriate formatting and relevant programming keywords within the prompts helps align the generated code with programming conventions. For example, using terms like “for loop,” “if-else statement,” or “variable declaration” in the prompt can guide the model's code synthesis process.

Developers can refine and adjust prompts based on the LLM's output, gradually improving the accuracy and quality of the generated code.

### SUMMARY

A core problem addressed herein is that of improved code synthesis using generative machine learning models. Aspects and embodiments herein enable program code to be synthesised automatically, or with greatly-reduced manual effort (semi-automatic synthesis). Various issues with conventional generative models are addressed.

One aspect herein provides a computer system for synthesising computer program code, the computer system comprising: a code synthesis component configured to receive an input, and cause a machine learning (ML)-based generator to generate an initial code artefact based on the input by submitting at least one prompt to the ML-based generator; a static analysis component configured to identify an error in the initial code artefact by applying a static analysis to the initial code artefact; a feedback component configured to indicate the identified error to the ML-based generator in at least one further prompt, causing the ML-based generator to generate an updated code artefact in response to the identified error.

In embodiments, a second error may be identified in the initial code artefact by applying the static analysis, and the static analysis may be configured to correct the identified second error programmatically, without feedback to the ML-based generator. For example, the program artefact may describe a software test, and the static analysis may be performed to determine that no test method is contained in the code artefact. In this case, the identified error is that no test method is contained in the code artefact.

As another example, the identified error may be a software dependency error. In performing the static analysis, the code synthesis component may attempt to correct the error programmatically, and the identified error may be indicated to the ML-based generator in response to the code synthesis component failing to correct the error.

The second identified error may also be a second software dependency error (which can be corrected programmatically).

The updated code artefact may be generated by indicating the error to the ML-based generator, instructing it to generate a reflection (e.g. in natural language) based on the error, and instructing it to generate the updated code based on the reflection.

The input may comprise a program design artefact or another code artefact.

Further aspects provide computer-readable instructions configured, when executed on one or more processors, to implement the system functionality of any aspect or embodiment described herein, and computer-implemented methods of implementing the same.

### BRIEF DESCRIPTION OF FIGURES

Illustrative embodiments will now be described, by way of example only, with reference to the following schematic figures, in which:

FIG. 1 shows a highly-schematic block diagram of a program synthesis platform;

FIG. 1A shows a simple reflection mechanism;

FIG. 1B shows a direct feedback reflection mechanism;

FIG. 1C shows a multi-stage feedback mechanism;

FIG. 2 shows further details of a program synthesis platform;

FIG. 3 shows a high-level overview of a requirements discovery process;

FIG. 4 shows a block diagram of a requirements discovery pipeline;

FIGS. 5A-C show a sequence of views rendered in a requirements discovery user interface;

FIG. 6 shows a requirements feedback view within a requirement discovery interface;

FIG. 7 shows a block diagram of a synthesis pipeline;

FIG. 7A shows further details of a synthesis pipeline;

FIGS. 8A-C demonstrate certain principles of update propagation through a synthesis pipeline; and

FIG. 9 shows an example of modified code containing a modification marker, and resulting updated code.

### DETAILED DESCRIPTION

### 1. Platform Overview

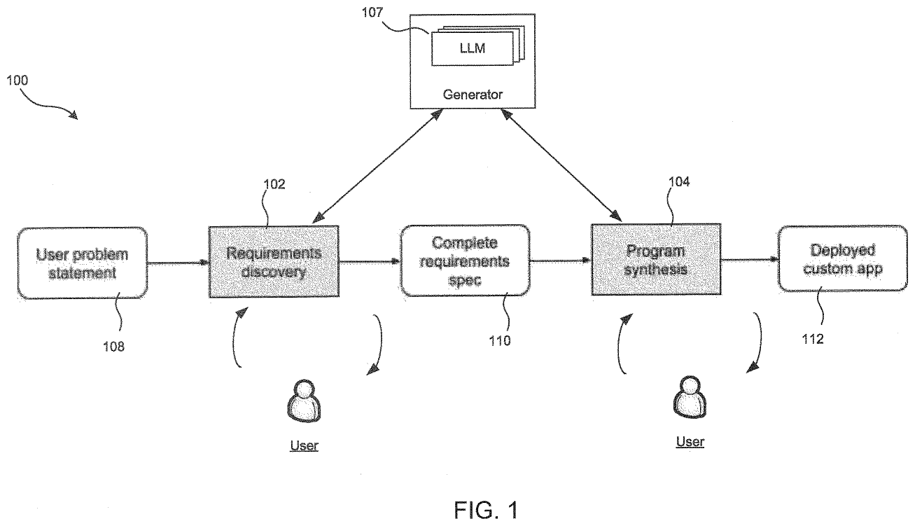

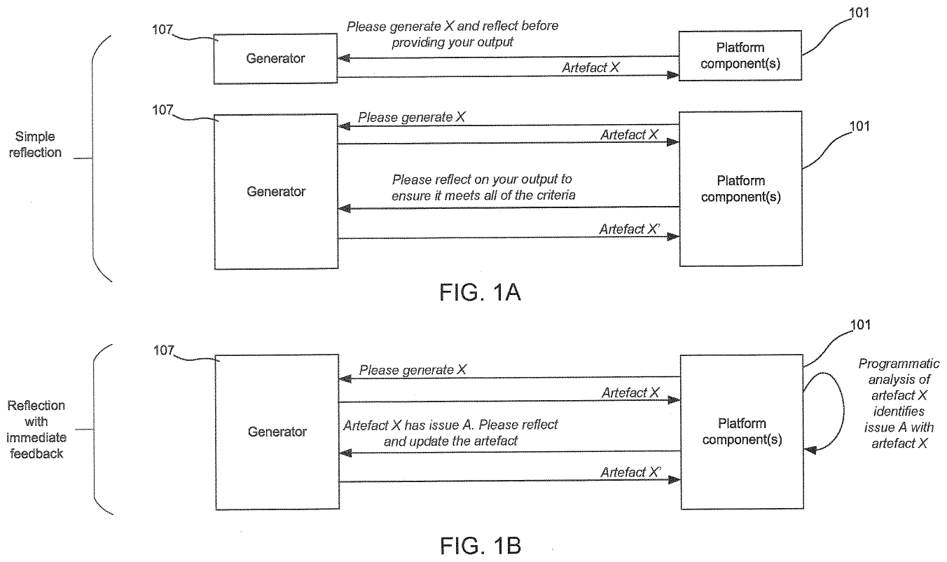

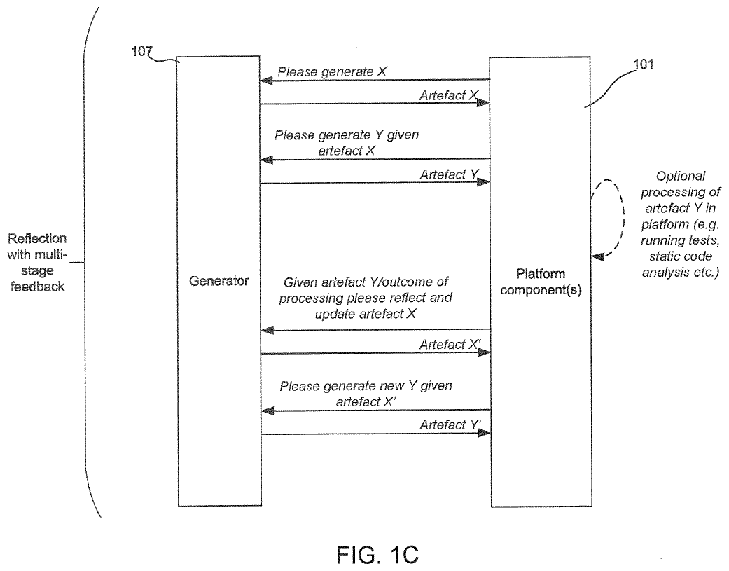

FIG. 1 shows a high-level block diagram of program synthesis platform 100, which is capable of synthesising a computer program in the form of a software application 112. The application 112 is synthesised in a sequence of iterative software design stages. A ‘project’ encompasses all stages involved in the synthesis of an application, from requirements discovery through to program design and, ultimately, code synthesis.

The platform 100 comprises two main components: requirements discovery, and program synthesis. FIG. 1 shows a requirements discovery pipeline 102 and a synthesis pipeline 104. A user inputs a program description in the form of an initial problem statement 108, which is used to generate a set of program requirements 110. This is an iterative requirements discovery process, in which the user is asked to confirm that the requirements are correct. The user can also request modifications to requirements through an interactive requirements discovery user interface. The aim is to generate a complete set of software requirements 110 through guided interactions with a reasonably non-technical user. Additional user inputs are provided during the requirements discovery process, as described in more detail below.

The software requirements 110 are inputted to the synthesis pipeline 104, which uses those requirements 110 to synthesise the software application 112, which in turn involves synthesizing program code for the application 112. At this stage, code is typically synthesised in the form of source code in a defined program syntax (such as Python, JavaScript etc.). 2

Web applications, such as Python web apps, can be generated that serve a frontend. Python has some useful characteristics in this context. Firstly, only a single application needs to be synthesised to serve both frontend and backend, and current generative models are extremely good at generating Python code as it is a common language. However, there is nothing to restrict the platform 100 to Python and it can be applied to generate any form of code within the knowledge of the generator 107. Applications can be generated that support multiple concurrent users and maintain state if necessary.

The platform 100 is particularly well suited to building applications that automate relatively manual workflows. This is particularly beneficial to users who, to date, have been limited by the tooling they have available to them, and have no means to build better tooling because of the significant costs attached to conventional software development.

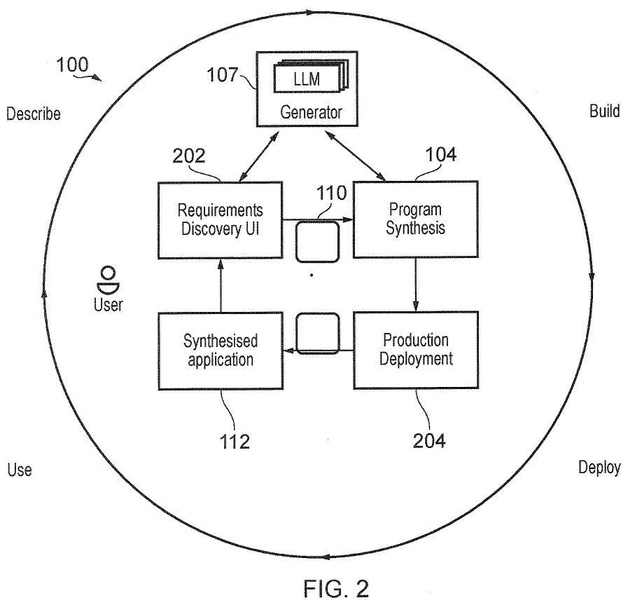

The program design/synthesis flow shown in FIG. 1 reflects a single iteration of the process. In practice, the process may be performed in a ‘loop’ of multiple iterations as users update their requirements after using their application to e.g. add new features (this loop is visualized in FIG. 2, which is described in more detail below).

The requirement's discovery pipeline 102 and synthesis pipeline 104 are supported by a generator 107 embodying at least one LLM 107. Herein, an ‘ML-based generator’ refers to a processing component which can receive a prompt (typically in the form of a variable-length character string, referred to as an input string) and generate a response (also typically in the form of a variable-length character string, referred to as an output string) using one or more generative machine learning models, such as LLM(s). References to ‘generated’ artefacts herein refer to outputs generated by a generative ML model, unless the context demands otherwise. Such components are typically implemented in software, but it is also feasible to implement such components using specialized hardware (such as application-specific integrated circuits (ASICs), field-programmable gate arrays (FPGAs) etc.). An LLM-based generator embodies one or more LLMs, and applies at least one of the LLMs to the inputted prompt. An LLM, has the form of an algorithm and a set of parameters, which have been learned through structured training on a very large dataset. A single LLM may be sufficient. Alternatively, multiple LLMs may be used (for example, multiple LLMs may be prompted and their outputs may be compared, or different types of prompt may be provided to different LLMs). As another example, an LLM might include a modifiable input parameter (such as ‘temperature’ which is a value that controls the model's ‘creativeness’), and a prompt may be processed multiple times with different values of the input parameters. When multiple responses are generated (e.g. with different LLMs and/or different input parameters), the generator may include logic for selecting one of the responses. Alternatively or additionally, with multiple LLMs, in some cases, a generator may include logic for selecting an appropriate LLM (or subset of LLMs) to process a given prompt. The following description may refer to a single LLM for conciseness. However, such description applies equally to other forms of generator. The generator 107 may be internal to the platform 100, or external, or it may comprise a combination of internal and external models. For the avoidance of doubt, an ML-based generator can, for example, be a collection of generative ML models, not all of which have to be used at every stage of requirements discovery/synthesis. For example, a first generative model of the ML-based generator might be used for requirements discovery, and a second generative model of the ML-based generator might be used for code synthesis. In this case, the ML-based generator May include appropriate model selection logic, implemented within the platform 100.

The platform 100 is capable of synthesizing modular computer programs, made up of multiple program components and/or multiple program files (or other discrete program elements). In this context, a ‘component’ refers to a modular and self-contained unit of a software system that encapsulates a particular functionality or a set of related functionalities. Components are synthesised along with component-level tests that allow the components to be tested individually. For example, each component may be contained in an individual program file, or a component may comprise multiple program files. In the examples below, an ‘implementation’ is generated per component, in the form of one or more code artefacts (such as one or more program files or other program elements).

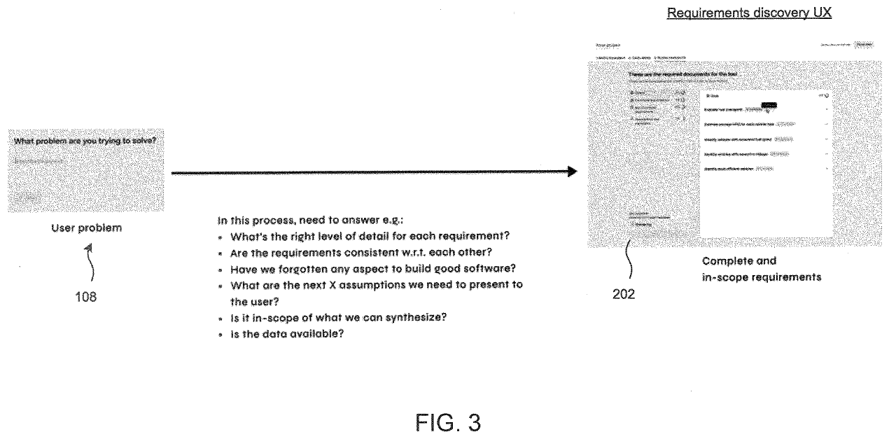

In the requirements discovery phase, the user is guided to produce a sufficiently precise and comprehensive set of requirements. Along-side the requirements, a high-level program structure (FIG. 3, 300) is generated according to a predefined program structure 300 schema. The high-level program structure 300 will not necessarily reflect the final structure of the synthesised program. Rather, it is used in the requirements discovery phase to help identify and rectify issues such as missing, incomplete or ambiguous requirement(s). It may be possible to rectify such issues automatically though reasonable assumption, or the user may be asked to provide specific pieces of required information.

Once adequately defined, the requirements are passed to the synthesis pipeline 104. The requirements are not used to synthesise code directly. Rather, code synthesis is performed in multiple further design stages, starting from those requirements. First, a technical design is generated from the requirements. The technical design is used to generate a software skeleton, including a file structure for the program. Finally, program code is synthesised for each program file within the file structure. Although each file is synthesised individually, the wider context of the requirements, the technical design and the software skeleton guide the code synthesis, providing wider context. These higher-level elements guide the eventual program synthesis, and are examples of program “design artefacts” as that term is used herein. Generated artefacts may include, for example, program design artefacts and synthesised program components/tests (referred to as ‘code/test artefacts’). A design artefact could also be a code artefact, e.g. containing template or boilerplate code to be refined/completed. The term program artefact is used to refer to code artefacts, higher-level descriptive artefacts, text artefacts and the like. Program design artefacts (e.g. software requirements, technical design, software skeleton etc.) can take various forms, such as a document (e.g. semi-structured document) or structured form such as a graph or tree (e.g. defining individual elements of a program design artefact and hierarchical relationships between them).

In addition, the requirements, the technical design and the software skeleton are used to design tests, with a test program file structure. Each test program file is synthesised in the same way.

In some implementations, generative ML techniques are used in combination with ‘classical’ programmatic techniques, such as programmatic code/artefact generation based on predefined templates or structures etc. Hence, in some such implementations, a code artefact or program design artefact may be generated using a combination of generative ML processing (e.g. based on one or more text-based prompts) and programmatic processing (e.g. predetermined rules applied to defined structures, templates etc.). For example, artefacts May be constructed in accordance with a domain specific language (DSL) or collection of DSLs that precisely defines their structure and syntax. For example, programmatic processing may be used to generate, from a first structured artefact (e.g. set of requirements), a second structured artefact (e.g. technical design, software skeleton, code artefact etc.) using predefined rules that leverage the DSL structure and syntax, with generative ML techniques used to synthesise one or more artefact portions (e.g. via one or more prompts to an ML-based generator) that are incorporated in the second artefact. Portions of design artefacts and/or code artefacts that are synthesised using generative ML can be refined or modified within the pipeline using the techniques described herein.

Each phase uses an LLM or set of LLMs that is assigned a specific software design role(s), such as software requirements engineer, software architect, software engineer etc. This is achievable, for example, by commencing an LLM prompt with text such as “You are a staff software engineer . . . ”, “You are a software architect . . . ” or “You are a writing assistant that exclusively writes software requirements documents, as you may see in e.g. large corporation or governments when they work with software consultancy firms.”, followed by clear and straightforward natural language instructions that define the task at hand, clearly and precisely, but affording the model(s) sufficient leeway to apply their training, and avoiding model confusion through ‘over-engineered’ prompts with excessive or confusing detail. To further aid illustration, example prompts to support various stages within the pipeline are given below. These are illustrative rather than exhaustive. The following examples mainly consider design artefacts in the form of documents. However, the principles and techniques can be applied to other forms of artefact, such as artefacts structured as trees or graphs. When other forms of artefact are used, prompts may be modified accordingly (for example, an LLM may be prompted to generate a smaller portion or portions to be included in a larger structured artefact, rather than an entire artefact, or be prompted to modify a previously-generated portion of an artefact).

“Self-reflection” techniques can be used at any stage of the pipeline. Self-reflection is a recent technique, explored for example in Shinn et al. “Reflexion: Language Agents with Verbal Reinforcement Learning” (2023), arXiv: 2303.11366v3 [cs.AI] supported by https://github.com/noahshinn024/reflexion, each of which is incorporated herein by reference in its entirety. For example, the model may be prompted to reflect and check that its output is complete and satisfies all requirements provided in the prompt (using words to that effect). For example, when tasked with generating a technical design document from a set of requirements, an LLM may be prompted as follows: “Before finishing, reflect and check that the document is complete and that all requirements in the requirements document are satisfied and covered in the technical design document.” Reflection may involve two stages:

firstly, the LLM is asked to reflect on its output, and identify any problems, but is instructed not to solve identified problems at this stage; rather, it is prompted to give, say, a few sentences describing what went wrong, as ‘hints’ for a subsequent re-attempt (its ‘reflection’). The reflection is then fed back, prompting the LLM to revise its previous output in view of this reflection.

In the described platform 100, several forms or reflection are implemented, at various stages.

FIGS. 1A-C illustrate several forms of reflection involving the generator 107 and one or more platform components (such as the requirements discovery pipeline 102 and/or the code synthesis pipeline 104). A single platform component 101 is referred to for simplicity, but the description applies to exchanges involving multiple platform components (e.g. with feedback from the code synthesis pipeline 104 to the requirements discovery pipeline 104, or vice versa).
1. FIG. 1A: ‘Simple reflection’. In this case, the generator 107 is simply directed to reflect in general terms, and the platform 100 is reliant on the generator 107 to identify and fix issues through self-reflection. The generator 107 may produce an initial artefact (artefact X) given a prompt(s), and the platform component 101 then asks it to reflect on artefact X given the earlier prompt(s), resulting in an updated artefact (artefact X′). Alternatively, the generator 107 is simply instructed to reflect before providing any output, resulting in an initial artefact (artefact X) on which it has already self-reflected.
2. FIGS. 1B-C: ‘Reflection with feedback’. In this case, some form of processing is performed in the platform 100 external to the generator 107 or by the generator itself but in a different context. Broadly speaking, such processing can take two forms:
   i. Processing that is typically programmatic in nature, and does not involve the generator 107 (‘external’ processing from the generator's perspective). This is particularly useful when the outputs are structured in a way that can be parsed, run, executed etc. Examples of such processing include static code analysis, parsing of output data structures, running tests through execution of program and test code etc. There are various subcategories of reflection with feedback, including:
   ii. Processing that does involve the generator 107, instructed to perform some other task, perhaps in a different role. In this case, the platform is providing feedback to the generator 107 from itself. Examples of reflection with feedback include the following:
   2a. FIG. 1B: ‘Immediate feedback’. In this case, the generator 107 produces some artefact (artefact X), which is processed within the platform 100 outside of the generator 107. An issue (issue A) is identified with artefact X (e.g. cannot be parsed, static analysis issue, etc.) and this is fed-back to the generator 107 with a specific instruction to consider issue A. For example, if the generator 107 generates a test file which does not contain any test method, and this is identified via static code analysis, this may trigger a prompt back to the generator 107 such as “Hey we expected a test, but you didn't generate a test, try again”. This prompt causes the generator 107 to generate new test(s).
   2b. FIG. 1C: ‘Multi-stage feedback’: this can be used in a context where first and second artefacts (artefact X and Y) are generated by the generator 107 at different pipeline stages. For example, artefact X might be an input used to generate artefact Y, or vice versa, or artefact X and artefact Y may be related in some other way (e.g. they may be code artefacts of the same application). The generator 107 is then prompted to reflect on artefact X given artefact Y (or some information derived from artefact Y), which may eventually result in an updated artefact X′. Artefact X′ could, for example, then be passed back to the generator to generate an updated artefact Y′, if 18 appropriate. In some cases, artefact Y is simply fed back to the generator 107, with a 19 relatively general instruction to reflect on any implications of artefact Y for artefact X. In other cases, artefact Y may be processed in some manner, and the outcome May be fed back to the generator 107. The generator 107 may be instructed to reflect on specific (e.g. predetermined) matters (e.g. “does artefact Y spawn any new requirements?”, or “How would you modify code artefact X to account for the outcome of test Y?”), but specific issues with artefact X are not necessarily identified or indicated. This is somewhat closer to ‘simple reflection’, in that the platform is relying on the generator 107 to identify and fix issues, and is simply guiding the generator by passing feedback to/from the generator 107 operating in different contexts.

A third outcome is also possible when an issue with an artefact is identified, either programmatically without involving the generator 107, or an issue with the generator 107 has been identified through reflection:
3. ‘Direct modification’: an issue with an artefact is of a nature that it can simply be corrected programmatically (e.g. resolving a missing dependency in generated code when the intended dependency is clear). The correction of the artefact does not involve the generator 107. No reflection is triggered by the identified issue; it is simply corrected programmatically.

With 2a or 2b, feedback exchanges may be performed iteratively in a ‘feedback loop’, continuing to generate updated artefacts and identify issues until no issues remain or some other termination criterion is satisfied.

It is useful to briefly consider a few specific examples (further details are described below):
a. One example of 2a and 3 occurs in the synthesis pipeline 104, where programmatic analysis may be used to identify various issues in synthesised code, and to correct some of those issues programmatically (option 3); the generator 107 is instructed to reflect on the remaining issues, eventually resulting in an updated artefact (option 2a). The same type of feedback is used to refine the technical design and the software skeleton in the earlier stages.
b. One example of 2b also occurs in the synthesis pipeline 104. The generator 107 is instructed to generate code (code artefact X) and tests (test artefact Y). The tests are run on the code, and the outcome of the tests may trigger a prompt back to the generator 107 to update a code artefact based on a test outcome. This involves processing of the code and test artefacts to run the tests and provide feedback on the outcome. 22
c. Another example of 2b in the synthesis pipeline 104 might be a static code analysis performed on a first code artefact (artefact X), the outcome of which is fed back to reflect on and update any implications for a second, related code artefact (artefact Y). Similarly, a first data structure artefact might be parsed to identify any issues, with the outcome fed back to reflect on any implications for asecond, related data structure artefact. 28
d. Another example of 2b occurs in the requirements discovery pipeline 102, in which an initial set of requirements is generated (artefact X), which in turn is used to generate an initial program structure (artefact Y), which in turn is fed back to the generator with a general prompt(s) to reflect on the program design and consider whether updates are needed to the requirements (resulting in updated requirement X′). This relies on the generator 107 to identify any issues with the requirements in light of the program structure.
e. 2a may also be used in the requirements discovery pipeline. For example, the program structure and/or the requirement document may be parsed to verify that it complies with the instruction format/schema, with issues fed back to the generator 107 for correction.

More generally, any of the above mechanisms can be combined at any stage of the platform. For example, when an artefact is produced, programmatic analysis may be used to identify various issues, and to correct some of those issues programmatically (3 above); the generator 107 may be instructed to reflect on the remaining issues, eventually resulting in an updated artefact (2a above). The updated artefact may then be passed back to an earlier stage (2b above) for further reflection and updates.

Whilst FIG. 1C considers feedback across two ‘stages’ (artefact X->artefact Y), such a feedback mechanism can be implemented across three or more stages (e.g. generate artefact X->artefact Y->artefact Z; process artefact Z to identify issue with artefact X and feedback to first stage to obtain new artefact X′ and so on).

In all cases, reflection may be performed in multiple steps, e.g. with the generator 107 initially prompted in a first step (in one or more prompts) to consider the error, and reflect on it to provide, say, an explanation in natural language of what went wrong and/or brief instructions as to how the error might be fixed (but not to produce an updated artefact or ‘solution’ at that point). ‘Multi-step reflection’ has been demonstrated to improve generator performance on various tasks. For example, the generator 107 may be asked to provide a few sentences of ‘hints’ to its future self, tasked with fixing the issue. Having received the generator's output of the first step (the ‘reflection’), this reflection may then be provided back to the generator 107 in a second step (in one or more prompts), with an instruction to implement the reflection and generate a new artefact. The generator 107 may be instructed to provide the reflection in natural language (to be fed back to itself) as the generator is optimised for receiving natural language inputs. As discussed in more detail below, exchanges of this nature can take place in one or more ‘chats’ with the generator 107. Within a chat, the generator 107 has context from any earlier chat history. If an exchange is conducted across multiple chats, the generator only has context, within any given chat, of any related other chat(s) to the extent such context is explicitly provided though prompt(s). For example, a generator 107 might be interested to reflect in one chat, and then its reflection may be passed to it in a different chat 107, with an instruction to implement it. Alternatively, the instruction to reflect and the instruction to implement the reflection could be provided in the same chat, or even in the same prompt (e.g. a single prompt that instructs the generator to output a reflection in a first part of its output, then implement this reflection in a second part). As will be appreciated, a suitable prompt strategy can be refined for a given model or models though routine experimentation in light of the teaching presented herein.

FIG. 2 shows further details of the synthesis platform 100.

A requirements discovery user interface (UI/UX) 202 is provided to enable interaction between the user and the requirements discovery pipeline 102.

A deployment pipeline 204 is provided, in which the synthesised application 112 is deployed to a production environment (e.g. a server, such as a web server in the case of a web application, or a local machine operated by the user in the case of a local application). In general, a production environment refers to a computer or system of networked computers in which the application 112 is executed. Deployment of the application may involve assembling and compiling the code of the application 112 ‘ahead-of-time’ (AOT) into low-level executable code (such as machine code, bytecode etc.). It is also possible to synthesise source code that is susceptible to ‘just-in-time’ (JIT) execution, such as JavaScript. Such code does not need to be compiled prior to runtime and can instead be compiled dynamically at runtime. Certain forms of code (such as Python code) may be susceptible to either JIT or AOT compilation, in which case an appropriate choice can be made.

The program synthesis process is depicted as a loop in FIG. 2, as in practice it is an iterative process as users update the set of requirements 110 after using the application 112 to e.g. add new features, modify existing features etc.

Further details of the technical architecture of the program synthesis platform 100 are described below. Additional details of the components of FIGS. 1-2 are described. An underlying LLM infrastructure is described. The described architecture addressed various challenges pertaining to automated (or semi-automated) program synthesis.

### 1.1. LLM Models and Infrastructure

A possible LLM architecture is described, together with a viable prompt engineering strategy that may be implemented within the program synthesis platform 100. Developments in LLM technology are moving at pace, and it will be appreciated that the range and capabilities of LLMs will only increase. It is emphasised that the LLM models and prompt engineering strategies are described purely by way of example, to assist the skilled person in putting embodiments of the present disclosure into effect. Other LLM models and prompt engineering strategies are viable, and additional models and prompt engineering strategies will become viable as the field develops.

In the present example, OpenAI's GPT-4 8k model is used, with the option of a fallback to the 32k model (rarely-required in practice). It is observed that the code generation and reasoning capabilities of GPT-4 are a large step up from the GPT-3.5 model. Whilst GPT-4 has a higher latency, in the present context, there are few real-time latency requirements. Nevertheless, to improve overall processing efficiency (and reduce overall latency), it is possible to offload simpler tasks to smaller models with lower latency, either hosted internally within the platform 100 or via an application programming interface (API) exposed by an external LLM.

Relevant data may be captured through usage of the platform 100 to enable bespoke models to be trained or fine-tuned.

During requirement discovery, user feedback regarding the generated requirements 102 is captured. Requirements are also linked to each other and, during synthesis, individual requirements are linked to other generated artefacts (such as generated code, tests, etc.). In this manner, the platform 100 generates a rich dataset of not merely code, but also detailed descriptions of what the code was intended to do. This dataset is far richer than outputs that are typically obtained using conventional code generation tools.

With fine-tuning infrastructure and powerful code generation models becoming available and affordable very quickly, the incorporation of bespoke-fine-tuned models is feasible. The rich datasets generated within the platform 100 can be used to improve the performance of both requirement and code generation.

Whilst fine-tuning on bespoke datasets can improve the performance of the platform, fine-tuning is not required, as acceptable performance is achievable using ‘out-of-the-box’ models.

### 1.2. Context Retrieval

Context is important to make LLMs work in practice. An LLM processes an input in the form of a sequence of data units (e.g. tokens). The context window of an LLM is the maximum size (in tokens) of the input and the generated output combined. For example, an LLM with an 8k context window can handle up to 8192 tokens in the input and output combined. So, with, say, a 1000-token prompt, the response can be at most 7192 tokens. Vice-versa, with a 6000 token prompt, the response can be at most 2192 tokens. While context window sizes are increasing rapidly, the Applicant has found this does not necessarily lead to large performance gains, as the likelihood of the LLM ignoring certain instructions in a prompt increases with the size of the context window. Indeed, the Applicant has found that asking LLMs to perform very specific tasks, accompanied by carefully crafted smaller contexts but with only information relevant to that specific context, typically yields improved results.

To craft these contexts, a vector store(s) may be used to perform semantic retrieval to find relevant information. Existing vector stores, such as Pinecone or Chroma, are available.

For structured data sources, such as code, the Applicant has found that these are not always necessary as it is feasible to programmatically find relevant segments of code to include in the context via static analysis of the synthesised code. Within the platform 100, static analysis of the synthesised application code may be used to identify targeted sections of code, which in turn can be identified in an LLM prompt(s), e.g. to modify the code directly, or to modify an artefact(s) produced elsewhere in the platform, as described later.

For data sources that are primarily natural language (NL), such as documentation or user problem statements, vector stores can be extremely useful. Within the platform 100, program description items may be generated that are NL-based, but which are also structured.

For example, the set of software requirements 110 may be generated in the form of a NL document in a specified Markdown structure (referred to as ‘requirements specification’ below). In that context, vector stores may be used in conjunction with structural information (e.g. a defined requirements structure) to craft targeted context windows, combining the power of semantic retrieval with static analysis.

It is possible to establish separate communication sessions (or ‘chats’) with the generator 107 (or an individual LLM within the generator 107). Within a session, the generator 107/model has access to all previous interactions in the same session (any earlier prompt(s) and any of its own response(s)). Therefore, one option is to maintain a number of ongoing sessions, with additional prompts provided in the same session to refine the various artefacts. However, in practice, the Applicant has found this can lead to ‘over contextualizing’, increasing the probability of the model ignoring earlier prompts and becoming ‘distracted’ by excessive earlier context. Therefore, it is generally preferable to operate on the basis of ‘atomic’ prompt-response exchanges, with all required context provided explicitly in an initial prompt or prompts, rather than relying on session history. Hence, a first session might be initiated with an LLM instructed to generate a set of requirements. When a user instruction is received, this may be provided in a second session, along with the requirements previously generated, within an introduction to the LLM to consider the given requirements, and modify them according to the user's instruction.

### 1.3. Supporting Tooling

LLMs are stochastic, high latency, rate limited, and relatively costly. Therefore, specific supporting tooling is deployed within the platform 100 to utilise LLM(s) effectively at scale in production.

For observability, caching, and cost-tracking, one or more LLM monitoring components may be deployed. One such component may be implemented using Helicone, which acts essentially as a proxy to LLM providers. This also enables the platform 100 to tag specific API requests with arbitrary metadata, enabling tracking of API usage e.g. per project or per user or user group.

To call an LLM API(s), a lightweight internal Python library is implemented in the platform 100, which deals with rate limiting, retrying, fallback models, etc.

### 1.4. Feedback and Human-In-the-Loop

Throughout the platform 100, LLMs are used heavily, wherever possible and desirable. However, in practice, it is often not feasible to one/few-shot a solution reliably. The Applicant has found that significant engineering and/or feedback loops are often required to usefully apply LLMs to real-world program synthesis tasks.

This insight has significantly influenced the design of the platform 100. In the requirement discovery UI 202, a human user is required to acknowledge generated assumptions 304 and requirements, thereby acting as a human-in-the-loop during the requirements discovery phase, to ensure the generated requirements 110 reflects the user's intention.

In the program synthesis process, automatic feedback is provided to the generator 107. Such feedback is produced in a reliable manner through programmatic analysis of the generated artefacts (such as test outputs, static analysis errors, etc.) As an example, if the generator 107 is prompted to generate a test, a programmatic check is performed in the synthesis pipeline 104 that the generated test comprises valid test code, that it is indeed a unit test, that imports are correct, etc. These feedback signals are important to achieve reliable and scalable code synthesis. Moreover, software programs are ideal sources from which to generate such feedback, as they are programmatically interpretable.

The synthesis pipeline 104 is also built to robustly accommodate human-in-the-loop functions, so that if the user wants to steer the pipeline in a different direction or make modifications to the requirements and/or software, they can do so quickly and reliably. For example, a user can edit a piece of synthesised code, and such modifications are propagated (where applicable) into higher-level description items used to generate the code, which maintains consistency within the pipeline, and also enables a user's edits to be interpreted and implemented with appropriate wider context. Similarly, a user can modify a higher-level program design artefact, which is propagated through the pipeline in order to synthesise new code. Further details of human-in-the-loop code synthesis are described below.

### 2. Requirements Discovery

FIG. 3 shows a high-level overview of the requirements discovery process. The goal of requirements discovery is to guide the user from the initial problem statement 108 to a fully specified requirements structure. During the requirements discovery process, the generator 107 to assigned specified tasks and instructed to operate in specified roles in carrying out those tasks (such as writing assistant, software engineer, software requirements engineer etc.).

The requirements discovery process is designed to accommodate a user who is typically a problem expert, but lacks software engineering expertise (the user does not and should not have to ‘think like an engineer’). The requirement discovery UX 202 is designed in a way that any technicalities are hidden from the user and the user is mostly presented with requirements and assumptions to confirm and/or modify, but very few ‘open questions’. The user goes through a process of confirming/modifying requirements until they have a fully specified, complete requirements document that one could theoretically hand to an engineer, who in turn would be capable of unambiguously implementing it. To achieve this aim, various challenges are addressed in the platform.

2.1. Feasibility checking:

When users input their problem statement 108, and when they make edits to the requirements, the platform 100 checks that the tool they want is actually feasible.

When they want to do something that is currently infeasible, the platform 100 automatically suggests solutions to subproblems to them that are feasible, so that the user can always generate a useful tool at the end of the process. Feasibility here entails two main aspects: the input data required needs to be available, and the software to be built and its complexity need to be in-scope of what the synthesis pipeline 100 can achieve.

In addition to the problem statement 108, the user may be asked a small number of questions 301 to elaborate on aspects of the problem or the desired solution. The questions may be hardcoded in advance, or the generator 107 may be asked to generate (or refine/customize) a suitable set of questions given the initial problem statement 108. Either way, the user's responses are passed to the generator 107, to guide the generation of the requirements 110 and the program structure 300.

### 2.1.1. Input Data:

If the input data comes from a file, the platform 100 asks the user, via the requirements discovery UX 202, to upload a sample file as part of the requirements discovery, which in turn allows the platform 100 to extract the schema and ask the user clarifying questions if needed. Input data may also be obtained via a system integration(s) (further details below). Whether obtained from a file or a system integration, the platform attempts to link requirements to entities in the data schema to verify that the data required is indeed available.

### 2.1.2. Software Complexity:

In the early stages of requirements discovery, the generator 107 is prompted to judge whether a project is in- or out-of-scope. This is achieved by specifying a supported scope to the generator 107 and prompting it to judge whether a current project is in- or out-of-scope.

### 2.2. Consistency Checking:

When users generate requirements, especially for complex software, they might specify conflicting requirements or talk (indirectly) about inconsistent data objects in various parts of the requirements. A user who is a problem expert may make implicit assumptions, or fail to provide relevant context initially. As an example, in a work planning application, users may describe unassigned work items in one section, but then talk about assigned work in another section, without having described where the assignment happens.

### 2.3. Requirement Generation and Completeness Checking:

A key capability of the platform 100 is to generate relevant requirements for the user to verify. To do this effectively, the platform 100 assesses whether a current set of requirements is complete, in the sense of being sufficiently detailed so that the described application can be implemented unambiguously, but not so detailed that the user has to think at a technical level.

### 2.4. Data Understanding:

Significant domain knowledge is often captured in structured data (such as spreadsheets) and/or systems used by users. The platform 100 is capable of extracting data schemas and requirements from such data sources. A user can upload their existing spreadsheet or link to an existing data source, and the platform 100 can automatically analyse not only the data schema, but also the logic used on top of the data (such as spreadsheet formulae, macros etc.) and extract requirements from such logic. In the example of a work planning tool, if a user has implemented certain work planning logic in a spreadsheet, they can upload their spreadsheet and the platform 100 can automatically extract at least some of the requirements (e.g. work needs to be assigned, it's planned by week, etc.) from the uploaded spreadsheet.

### 2.5. Requirements Discovery Architecture

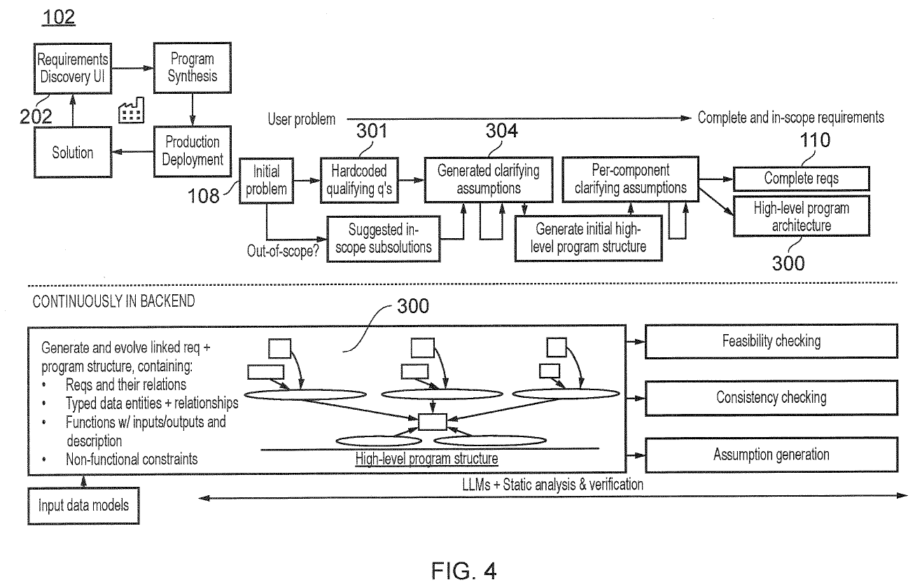

FIG. 4 shows a functional block diagram of the requirements discovery pipeline 102, which supports the requirements discovery UX 202.

To effectively generate complete, consistent and feasible requirements, the software requirements 110 are structured as a graph embodying child-parent and other relationships between the requirements, thus creating a hierarchical view of the requirements. For example, the generator 107 may be prompted to generate the requirements 110 using a specified Markdown structure.

Still within the requirements discovery pipeline 102, in addition to the requirements 110 themselves, the generator 107 is used to build the high-level program structure 300. Within the generator 107, multiple LLMs are used in parallel, running in the background to build the high-level program structure 300, which contains typed data entities and their relationships, functions with inputs/outputs and a description, non-functional constraints, etc. The program structure 300 is generated using a predefined data schema (such as a JSON schema), which the generator 107 is instructed to use in generating its output.

An example of a suitable LLM prompt to generate such a structure is given below.

The high-level program structure 300 is used primarily to guide the requirements discovery process. Having generated an initial program structure 300, this allows the platform 100 to have the generator 107 reflect on this structure 300 and ask targeted questions such as “given this program structure, what other assumptions are required to implement <particular function>unambiguously?”. The answers to such questions can then be fed back to the user via the requirements discovery UX 202, as assumed requirements that the user can verify. The user's responses may, in turn, result in modifications to the requirements 110, resulting in a modified program structure and so-on. The modifications could be modification of existing requirements, but they could also spawn entirely new requirements. For example, given a user's feedback, the generator 107 might be asked “given these requirements, and this piece of user feedback, list any new requirements spawned by the user's feedback.”

Similarly, the program structure 300 can be used to better understand and evaluate feasibility, inconsistencies, and completeness.

Looking at the pipeline as a whole, the platform 100 is essentially always generating the next artefact in the pipeline, which in turn informs questions that need to be asked (to the generator 107 and/or the user) in relationship to the previous artefact (so, in this case, the high-level program structure 300 is fed-back to the generator 107 to identify missing/incomplete requirements, which in turn allows the generator 107 to make appropriate assumptions to be fed back to the user).

Once the requirements discovery process is complete, the additional high-level program structure 300 can be used along with the requirements 110 themselves to guide generation of a technical architecture for the application to be synthesised. However, the program structure 300 is not required in this context; the application can be synthesised from the requirements 110 alone. Hence, the program structure 300 may or may not be inputted to the synthesis pipeline 104. Either way, the program structure 300 will not necessarily reflect the final program structure of the synthesised application 112, as the final program structure will be determined through the various stages of the synthesis pipeline 104.

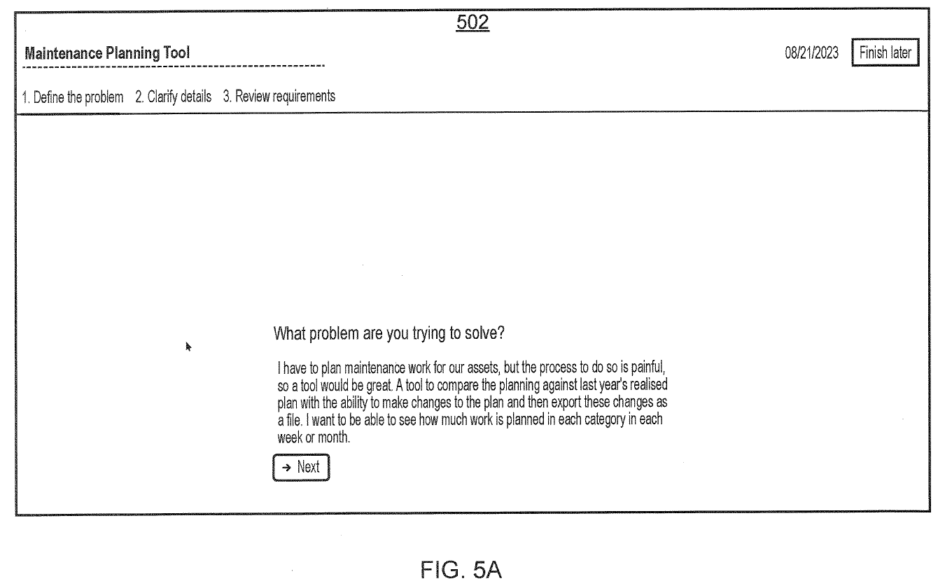

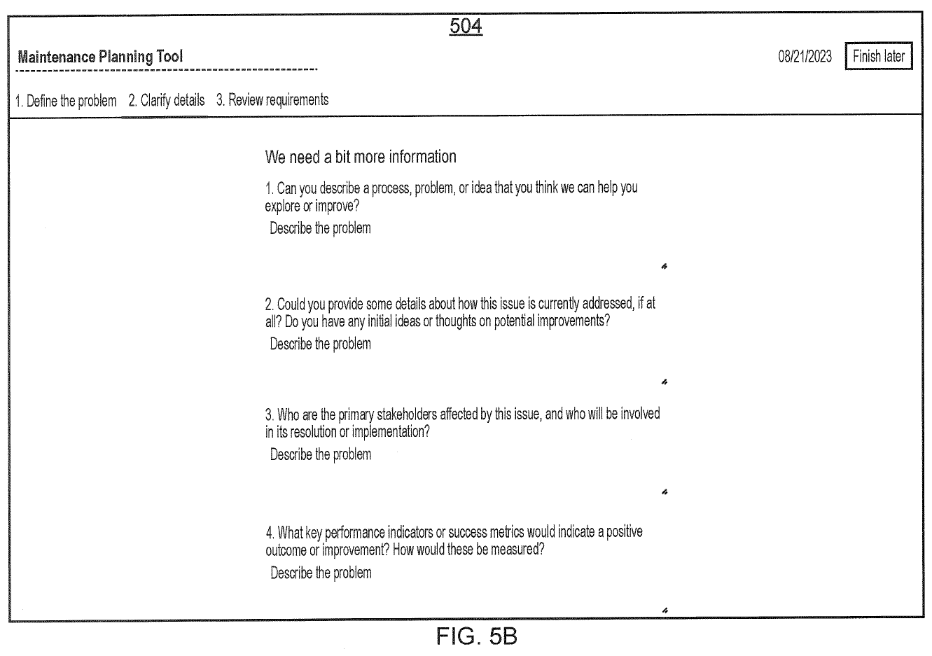

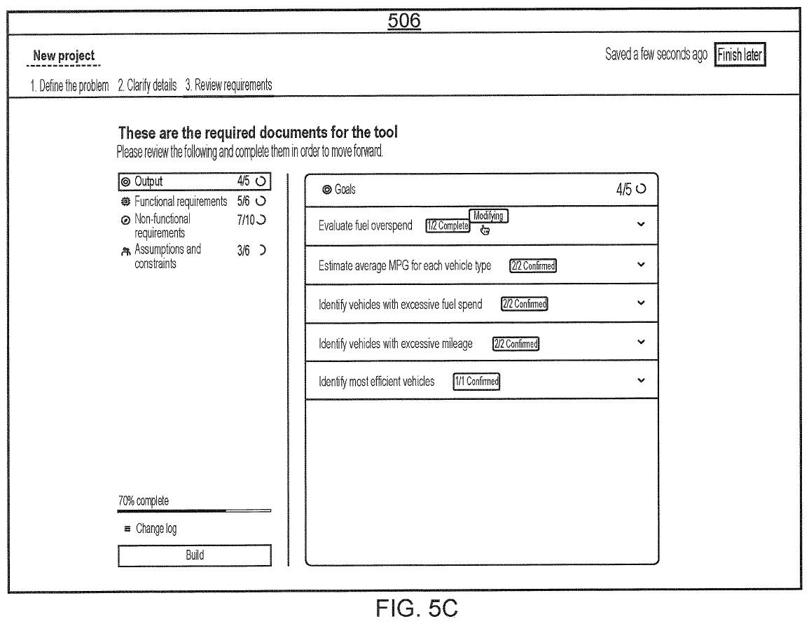

FIG. 5A-5C—show an example requirements discovery flow within the requirements discovery UX 202. A user enters a problem statement in a first page 502 (FIG. 5A). The user is then taken to a second page 504 (FIG. 5B), in which they input their responses to various displayed questions (hardcoded or model-generated). Assuming the problem is in-scope, the UX proceeds to a third page 506. The third page is shown at a time after the requirements discovery process is underway, and an initial set of requirements has been generated in the manner described herein. The user can then view each individual requirement, accept the requirement via the UX, or provide natural language feedback in a chat interface.

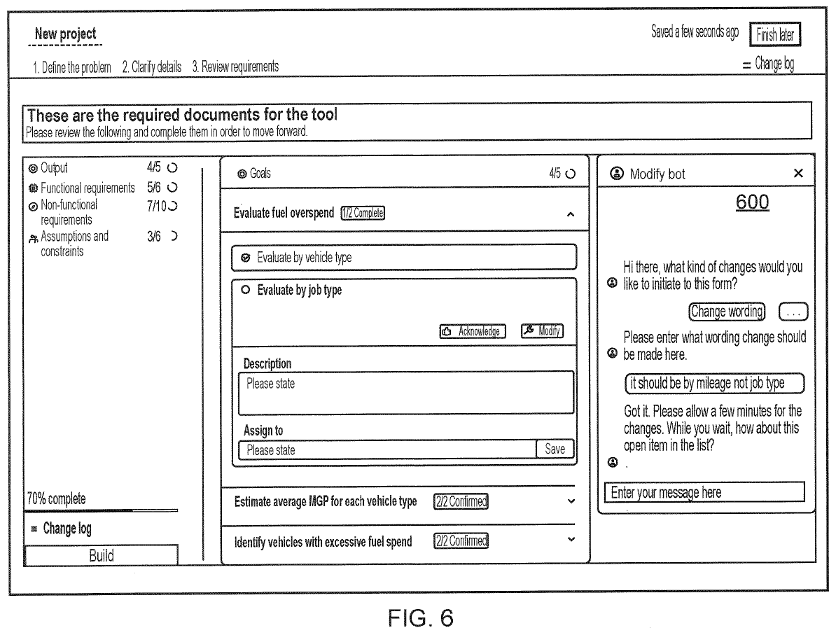

FIG. 6 shows an example of a chat interface view, with a chat window 600. The user does not necessarily ‘chat’ directly with the generator 107 at this point. For example, a simpler real-time proxy agent (e.g. rules-based) may be deployed. The user's comments are fed back to the generator 107 under the control of the platform, with instructions to consider the user's feedback and update the requirements (not just the individual requirement the user has commented on, but also to consider any wider ramifications, such as any required modifications to other requirement(s), or any new requirement(s) spawned by the user's comments).

### 3. User Interface Design

The platform 100 is capable of generating a user interface for the synthesized application 112. Describing visual interfaces in natural language is burdensome for users, and typically also inaccurate. Therefore, users are presented with a visual drag-and-drop interface where they can, at a high-level, design a desired interface using ready-made components in combination with natural language annotations. The synthesis pipeline 104 will then take this into account to try and synthesise an app with a UI constrained by what the user designed. This then also provides a strong feedback signal to the synthesis pipeline which will help in the quality of UI synthesis.

### 4. Program Synthesis

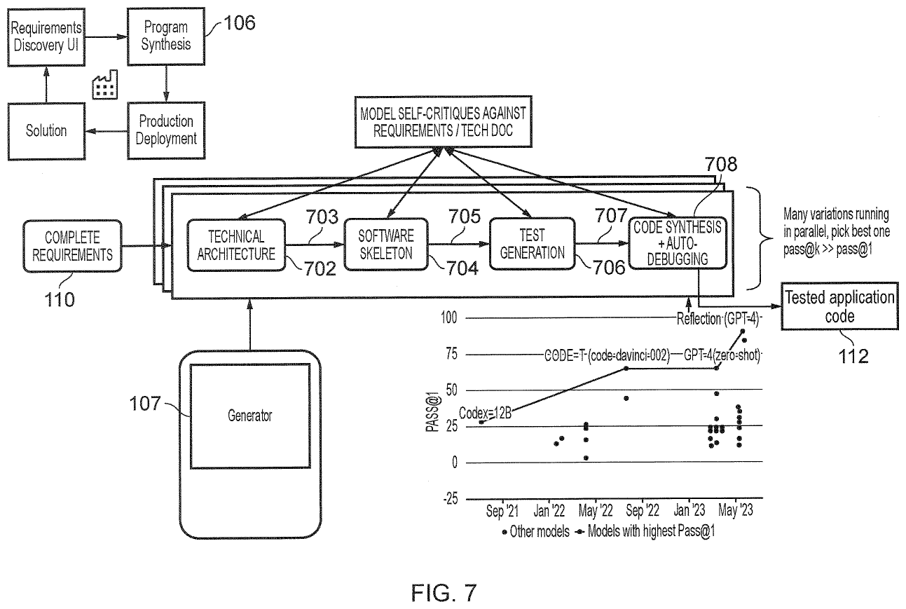

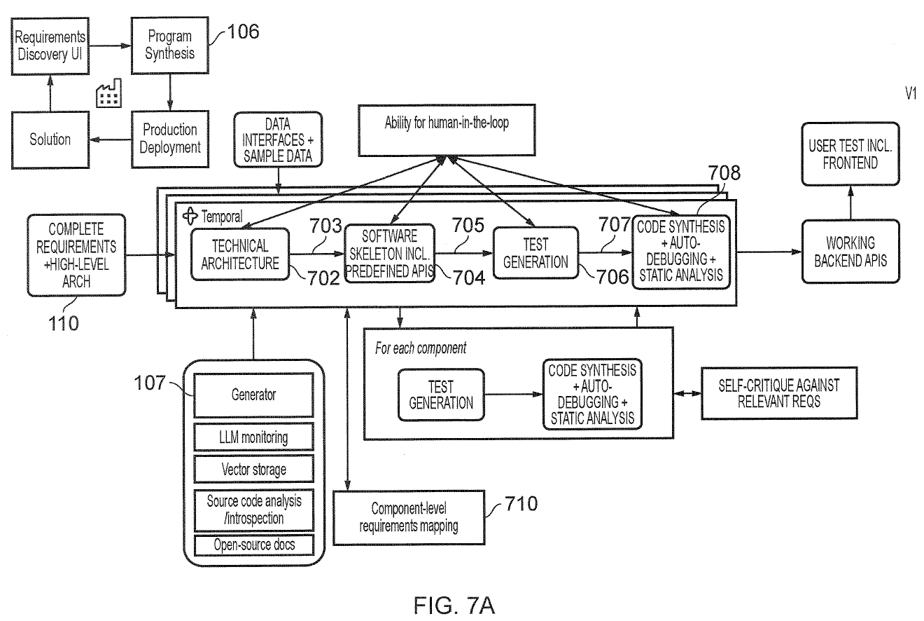

FIG. 7 shows a functional block diagram of the synthesis pipeline 106. Multiple stages are depicted within the synthesis pipeline: a technical design stage 702, a software skeleton generation stage 704, a test generation state 706 and a code synthesis 708 (which includes static code analysis and auto-debugging functions). Each stage is supported by the generator 107 prompted to operate in a defined role (or roles), such as software architecture, test engineer, software engineer etc., assigned specific tasks to carry out in that role. As in requirements discovery, the synthesis pipeline 106 operates one stage ahead, generating the next artefact in the pipeline, and reflecting on this to feed back to and refine the earlier stages.

The program synthesis pipeline 104 is capable of synthesizing varied software applications with minimal human interaction, purely from the set of requirements 110. With sufficient engineering effort, it is feasible to synthesise software completely automatically. However, the synthesis pipeline 104 can also incorporate human-in-the-loop features, to enable semi-automatic code generation with significantly greater efficiency than a human software engineer using conventional software development tools.

FIG. 7A shows further details of the synthesis pipeline 106, which depicts additional functionalities described herein.

The architecture of the synthesis pipeline 106 is guided by the manner in which a human engineer would write software. At its core, the synthesis pipeline 106 produces the following artefacts consecutively:

1. [Input] A complete requirements structure 110, rendered as a document, and optionally a high-level program structure 300 as described previously.
2. From the inputs of 1., a technical software architecture 703 is generated (e.g. in the form of a structured or semi-structured document), similar to what typically an engineer would write. This includes all components, API specifications, data formats, etc.
3. From the technical software architecture 703, a software skeleton 705 is generated. The software skeleton 705 comprises an initial set of program files. Within each file, all classes and methods are defined, as are their types. Documentation for the files is also generated at this stage. However, no implementation is defined at this point.
4. These three artefacts (the requirements 110, the technical software design 703 and the software skeleton 705) are used to generate unit tests 707 for each component, which is feasible as the requirements and all interface definitions have been obtained by this point.
5. Finally, an implementation is generated for each component. As noted, a component may be a single program file, or comprise multiple program files. Either way, in the present example, an implementation is generated per-component, but with per-file prompts. In this manner, an implementation is generated for each component in the form of one or more code artefacts generated by the generator 107 (where a code artefact may, for example, take the form of a program file containing complete code). Each code artefact is statically analysed to detect any issues that can be resolved automatically.
6. The tests generated in step 4 are then run on the code artefacts of step 5. If any test fails, the synthesis pipeline 106 prompts the generator 107 to reflect on the test output, together with the requirements 110, to try to identify a source of the failure. If the generator 107 is able to do so, the resulting output is then fed back to the generator 107 to fix the relevant files (i.e. back to step 5, with the additional context of the test results). This process is repeated until all tests are passed.

To do this successfully, various tools are implemented within the platform 100 to evaluate and guide the outputs of the generator 107. This is, to some extent prompt engineering. However, in addition to prompt engineering, performance is significantly improved with infrastructure to run the pipelines and programs reliably, building reliable output parsers, building static analysis steps, etc.

In practice, k runs of the synthesis pipeline 106 are implemented in parallel (e.g. using Temporal; see https://learn.temporal.io/tutorials/python/data-pipelines/), as each will give a slightly different result, and performance @k is much higher than performance @1. In practice, for a single program, the synthesis process typically takes 30 minutes or so until all tests pass, depending on the complexity of the software.

To obtain different results with a deterministic model, the input prompts may be varied slightly and/or external parameter(s) of the generator model may be varied (such as a temperature parameter).

### 4.1. Human-In-the-Loop Synthesis

The synthesis pipeline 106 has human-in-the-loop support, which gives the ability to (a) update the task at any time (e.g. update the requirements 110) and (b) steer and correct the model if it gets something wrong.

In order to do this, the overall pipeline (the requirements discovery pipeline 104 and the synthesis pipeline 106) is set up so that every step in the generation outlined above is committed to a version control repository (such as a Git repository), which acts as a single source of truth. A user can halt the synthesis process at any time, make changes to the repository, and resume the synthesis. The synthesis pipeline 106 will then pick up the changes made by the user and, importantly, propagate them throughout all artefacts. Within a version control system (such as a Git), a repository is created in which different versions of files can be stored and tracked over the course of a software development process. In this case, as LLM-generated artefacts are modified and refined (e.g. by a user, or automatically by propagating updates made elsewhere though the pipeline), new versions of the artefacts are added to the repository (retaining all previous version) in such a manner that changes over time can be easily tracked.

For example, the user can simply update the requirements 110, and the synthesis pipeline 105 will ensure that the technical architecture 703, skeleton 705, code 112, and tests 707 reflect the modified requirements 110. For example, the synthesis pipeline 104 may generate test(s) specifically to test the change in requirements. Vice-versa, a user can edit the code of the application 112 and if the user's edits reflect a change in requirements, then the requirements 110 will be updated based on the edited code. Edits to the code or tests of the application 112, or the requirements 110 are propagated through the pipeline, and may result in changes to the technical architecture 703, software skeleton 705 etc.

The synthesis pipeline 106 can also accommodate user-inserted comments in code, which contain high-level directions for the model, which it will pick up on and fix (akin to “FIXME” comments in traditional software engineering).

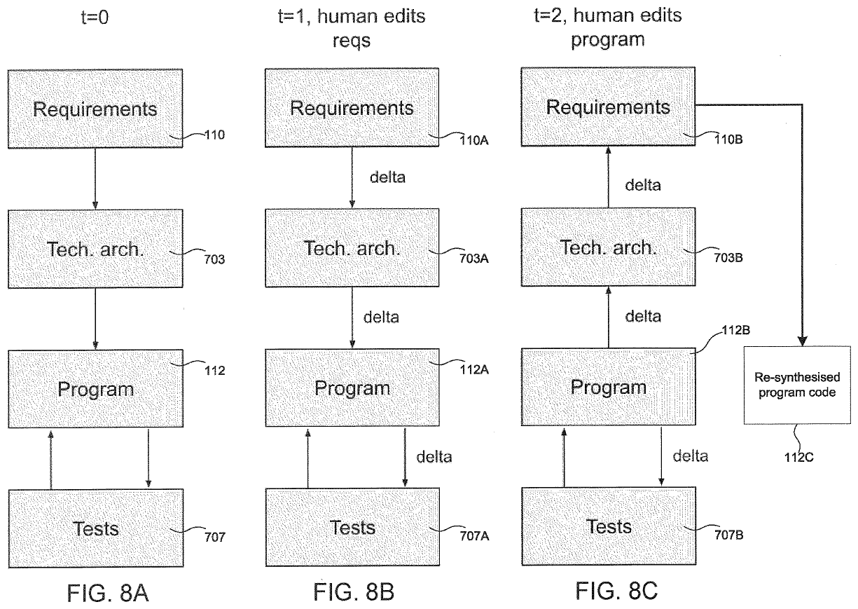

FIG. 8A shows a simplified program design and synthesis flow within the synthesis pipeline 106.

FIG. 8B shows a human modification to the requirements 110, resulting in modified requirements 110A. The modification (delta) is propagated downstream through the synthesis pipeline 106, resulting in an updated technical architecture 703A, re-synthesised program code 112A and updated tests 707A.

FIG. 8C shows a human modification to the code of the application 112, resulting in edited program code 112B. The edit to the program code (delta) is propagated ‘upstream’ resulting in a modified set of requirements 110B, a modified technical architecture 703B and modified tests 708C.

In both cases, edits are propagated through suitable prompts to the generator 107, providing any relevant context (such as an artefact or artefacts which have been modified, any relevant original artefact(s), an instruction to modify a given artefact(s) to account for changes in some other artefact(s)).

The edit to the program code may modify the functionality of the code, in which case the edited code 112B may reflect the user's final intention. Alternatively, the user may simply insert an instruction contained within the code itself (such as a ‘fixme’ comment) to be implemented by the generator 107. An instruction contained within the code itself is referred to as a modification marker herein. In this case, the edits are propagated both upstream and downstream: having generated the modified requirements 110B (upstream propagation), these may then be used to re-synthesise new program code 112C (downstream propagation) based on the modified requirements 110B.

Updates/modifications may also be propagated ‘across’ artefacts. For example, a first component might be modified, triggering a prompt or prompts to the generator 107 that result in an update to a second code component, either by prompting the generator 107 to update the second code artefact directly (e.g. “given these modification to component A, does component B need to be modified?”), or indirectly by updating some higher-level artefact (such as the software skeleton), which then results in a modification to the second component.

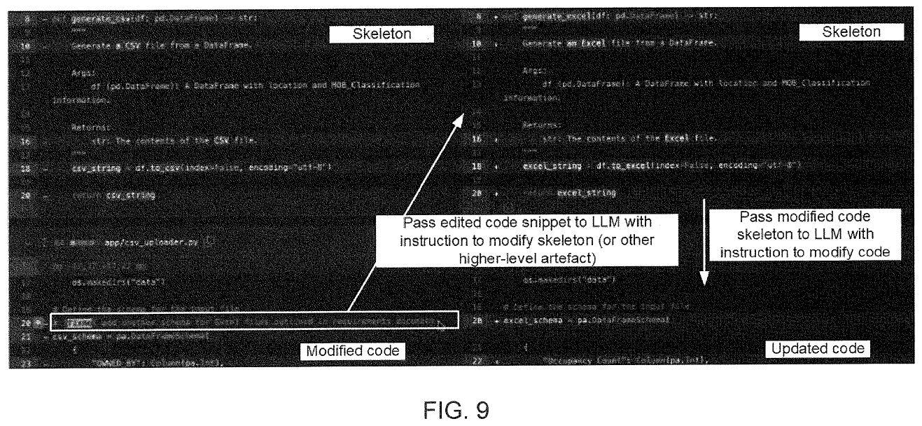

FIG. 9 shows an example of a section of code, which is displayed within a code editor interface, and contains a FIXME comment inserted by a user. The FIXME comment is propagated upstream through the synthesis pipeline 104, resulting in an updated software skeleton, which in turn results in code re-synthesis

To implement the ‘fixme’ functionality, an initial LLM prompt might, for example, be constructed as follows:

# Description: User can put ″FIXME″s in the code, this prompt then picks
up on them and then describes how to fix them.
FIXME_REFLECTION_PROMPT = f″″″
You are a staff software engineer. You will be given a technical design
document, a software implementation and a file with a set of [FIXME]
comments in it.
Your goal is to look at the [FIXME] comments and write a few sentences
to explain what the issue is that needs to be fixed and tell me which files
should be fixed.
You will need this as a hint when you try again later. Only provide the few
sentence description in your answer, not the implementation.
Output your answer in the following Markdown format:
‘‘‘
# Reflection
<YOUR REFLECTION>
# Files to fix
- ‘<FILE 1>‘
- ‘<FILE 2>‘
- ‘<FILE 3>‘
...
‘‘‘
″″″

The output can then be fed back to the generator 107, with a specific instruction, e.g. to modify the requirements 110 or technical design 703 to implement the fixes specified in the previous model output.

Such modifications can all be implemented by a deployment strategist completely from within the version control repository. The user can instantly start an integrated development environment (IDE) in-browser (VSCode) with a user project loaded, all artefacts present, and all dependencies installed, so that they can immediately go and run the app, and make any changes necessary, without ever leaving a browser context.

An even more streamlined process is feasible, where the synthesis pipeline 106 will proactively reach out to the deployment strategist if human assistance is needed.

### 4.2. Linking Requirements

Within the synthesis pipeline 106, specific requirements are linked to specific parts of the technical architecture 703, code, and tests (at the component-level). This is achieved by generating a requirements mapping (FIG. 7A, 710) using the generator 107 and then maintaining the requirements mapping 710 as updates are made to the code. This component-level mapping enables modularization of the synthesis pipeline 106. For example, this allows code synthesis and testing on a component-level before combining components to an overall program. In addition, this makes it easier to construct more targeted context windows and allows the pipeline 106 to ensure that each requirement has at least one (preferably several) unit tests.

The Applicant has found that LLMs are able to self-reflect effectively at the component-level, and optimal performance is achieved by breaking down the requirements and artefacts into smaller components; otherwise LLMs have a tendency to start ignoring some of the requirements.

### 4.3. Static Analysis

Generative ML techniques are particularly well suited to structured outputs, such as code, as automatic feedback loops can be implemented leveraging the known structure of the output. For code generation, such feedback loops can be implemented based on static analysis of generated code artefacts. Static analysis is a debugging technique in which the code is examined for errors without having to execute the code. Similar feedback techniques can be applied to other structured outputs generated within the platform 100 as these can be readily parsed. Feedback regarding the generated artefact which has been analysed may be passed to the generator 107 with an instruction to modify the generated artefact.

Feedback loops of this nature are implemented throughout the synthesis pipeline 106. Deployed in this manner, the effect is to greatly reduce the rate at which generative model(s) become “stuck”. Automated feedback also increases the overall speed of code generation.

Such analysis can range from relatively simple checks, such as determining whether generated code has valid syntax or that a generated test file does indeed contain a required number of tests, to more complex things like e.g. automatically resolving incorrect imports, analysing which dependencies should be installed based on imports (which, for certain generative models, has been found to be more reliable than asking the model to do this), checking an interface defined in generated file A is used in generated file B with correct data types, etc.

Static analysis (or structured output analysis more generally) can, in some cases, be used to directly modify a generated artefact (rather than providing feedback to the generator pertaining to that artefact). It is possible that a modification of this nature would need to be propagated upstream or downstream through the synthesis pipeline 106, in a similar manner as manual modifications (see FIGS. 8B-8C and the accompanying description above). For example, a modification to a code artefact may require the software skeleton 705 to be modified, or vice versa. Other modifications are such that no such propagation is required.

There is also ample scope for runtime analysis when tests fail, to e.g. provide better debugging information to the generator 107, resulting in better reflection performance, and thus higher success rates within the synthesis pipeline 106 as a whole.

### 5. Example Requirements Discovery Prompts

Example prompt strategies are described below that may be implemented at various stages of the requirements discovery pipeline 102 and synthesis pipeline 104. These are intended to be illustrative, rather than prescriptive or exhaustive, and should be read in conjunction with the more general teaching above.

Note that, with the human-in-the-loop features, a user can intervene at any stage to guide the generator 107 if required.

### 5.1. Initial Requirements Generation

The prompt below may be used to initiate a requirements discovery phase. The generator 107 is prompted to generate an additional set of software requirements.

SYSTEM_MESSAGE_REQ_DOC = “““You are a writing assistant that exclusively writes
software requirements documents, as you may see in e.g. large corporations or
governments when they work with software consultancy firms.
The user will initially tell you what kind of software they want to build. You
will then generate a requirements document for them.
You should always generate a full requirements document.
If the users' request is ill-defined or missing details, you should fill it in
with reasonable defaults and assumptions
Make sure to include at least the following sections:
* Functional requirements
* Non-functional requirements
* Input data
* Output data
* User Interface
* Data transformations and calculations (if applicable)
Do not output anything that is not part of the document, such as “Thank you for
your request” or “I will update the document”.”””

The user's problem statement 108, as entered in the first page (FIG. 5A, 502) of the requirement discovery UX 202), is provided to the generator 107 either in the same prompt or in a subsequent prompt in the same session.

In this case, a simplified structure for the requirements is specified. However, other requirements structures may be specified in a similar manner, such as a graph structure embodying parent-child relationships.

The examples below assume the requirements 110 are outputted in the form of a document, but the principles can be applied to other requirements structures. Either way, the requirements are not complete at this stage, and are refined over the course of the requirements discovery process.

### 5.2. Feasibility Checking

A prompt such as that given below can be used to instruct the generator 107 to conduct feasibility checks during the requirements discovery phase, given a generated requirement document (or other structure).

You are a software requirements engineer. You work for a large software
consultancy firm.
The user will provide you with a software requirements document. You should check
whether the requirements are feasible to implement in the following scope:
- Allowed data inputs: CSV files, Excel files, SQL databases, Salesforce, JSON
files. No images, PDFs, or other formats.
- Allowed data outputs: CSV files, Excel files, dashboards, reports. No images,
PDFs, writing to databases/APIs, or other formats.
- Data has to fit in memory
- The requirements are feasible to be implemented as a simple Python application.
Output either ″Yes″ (if it can be done in scope) or ″No″ (otherwise) to the user,
and nothing else. If the output is ″No″, also provide multiple alternatives that
*can* be done in the above scope. These can be subproblems, simpler analyses, or
other closely related solutions, but each one needs to be doable in the above
scope. Do not output anything else at all.
Your response is meant for a fairly non-technical user, so don't mention technical
details such as ″ETL pipeline″ or ″Python″.
You can provide a maximum of 2 alternatives.
If the input and output data sources are not clear, make a reasonable assumption
when you check feasibility.
Output format:
‘‘‘
Yes/No
1. [ALTERNATIVE 1, IF NO]
2. [ALTERNATIVE 2, IF NO]
‘‘‘

Note that the ‘user’ referred to in this prompt is, in fact, the platform 100 itself, which acts as a ‘proxy’ user between the actual user and the generator 107. The actual user is not required to provide the requirements document; rather, this has been generated by the generator 107 itself (from the user's simpler problem statement 108), instructed to operate in a different role. If the generator returns ‘Yes’, the requirements discovery UX 202 proceeds to the second page (FIG. 5B, 504). If ‘No’, the alternative options are outputted to the user, and the user can choose to select one of these instead.

A check could be performed at this point within the platform 100, e.g. parsing the set of requirements to verify that it has the correct requirements structure. If an error is identified, this could be addressed by modifying the structure of the requirements directly, or feeding back to the generator 107.

This prompt causes the generator 107 to assume a different role, and is provided in a separate chat, as putting different tasks in different chats tends to be more stable (the greater the extent of context that is not relevant to the task at hand, the higher the probability the model gets distracted).

### 5.3. Generating Program Structure

As indicated, a data schema for the high-level program structure can be specified. For example, a JSON program schema may be defined in the following manner.

```
COMPONENT_ANALYSIS_OUTPUT_JSON_SCHEMA = {
  “$schema”: “http://json-schema.org/draft-06/schema#”,
  “$ref”: “#/definitions/ComponentAnalysis”,
  “definitions”: {
    “ComponentAnalysis”: {
      “type”: “object”,
      “additionalProperties”: False,
      “properties”: {
        “entities”: {
          “type”: “array”,
          “items”: {
            “$ref”: “#/definitions/Entity”
          }
        },
        “relationships”: {
          “type”: “array”,
          “items”: {
            “$ref”: “#/definitions/Relationship”
          }
        },
        “functions”: {
          “type”: “array”,
          “items”: {
            “$ref”: “#/definitions/Function”
          }
        }
      },
      “required”: [
        “entities”,
        “functions”,
        “relationships”
      ],
      “title”: “ComponentAnalysis”
    },
    “Entity”: {
      “type”: “object”,
      “additionalProperties”: {“type”: “string”},
      “properties”: {
        “name”: {
          “type”: “string”
        },
      },
      “required”: [
        “name”,
      ],
      “title”: “Entity”
    },
    “Function”: {
      “type”: “object”,
      “additionalProperties”: False,
      “properties”: {
        “name”: {
          “type”: “string”
        },
        “inputs”: {
          “type”: “array”,
          “items”: {
            “type”: “string”
          }
        },
        “outputs”: {
          “type”: “array”,
          “items”: {
            “type”: “string”
          }
        },
        “description”: {
          “type”: “string”
        }
      },
      “required”: [
        “description”,
        “inputs”,
        “name”,
        “outputs”
      ],
      “title”: “Function”
    },
    “Relationship”: {
      “type”: “object”,
      “additionalProperties”: False,
      “properties”: {
        “name”: {
          “type”: “string”
        },
        “entities”: {
          “$ref”: “#/definitions/EntitiesInRelationship”
        }
      },
      “required”: [
        “entities”,
        “name”
      ],
      “title”: “Relationship”
    },
    “EntitiesInRelationship”: {
      “type”: “object”,
      “additionalProperties”: False,
      “properties”: {
        “from”: {
          “type”: “string”
        },
        “to”: {
          “type”: “string”
        },
        “from_key”: {
          “type”: “string”
        },
        “to_key”: {
          “type”: “string”
        }
      },
      “required”: [
        “from”,
        “from_key”,
        “to”,
        “to_key”
      ],
      “title”: “Entities”
    }
  }
}
```

An LLM prompt to generate the high-level program structure 300 using this schema (enabling the program structure 300 to be parsed) might then be constructed along the following lines. The prompt indicates the program structure schema, and includes a natural language explanation of its elements. The prompt also instructs the generator 107 to generate its output in the defined schema.

You are a software architect. You are given a requirements document and it is your job to define all data entities, their relationships, and any functions that take entities as inputs and produce new entities, that are needed for the backend of this program. This is akin to a high-level data-flow/program design. You define this in a JSON format.

```
Ignore anything related to the frontend; only design for the APIs needed to
support the frontend.
Explanation and examples of concepts:
- An entity is a data object. You can think of them as Python dataclasses. It
always has a name, and it can have properties that have a type. Example entity:
‘‘‘json
{
  ″name″: ″Invoice″,
  ″id″: ″str″,
  ″amount″: ″float″,
  ″customer_address″: ″str″,
  ″company_address″: ″str″
}
‘‘‘
- A relationship is a direct relationship between two entities that does not
entail any processing (that would be a function). For example, the entities
MileageDataPerVehicle and and Vehicle could be related by a property ″vehicle_reg″
that refers to the ″id″ of a vehicle. from/to are always entities,
from_key/to_key, are properties on those entities. In that case an example
relationships could look like:
‘‘‘json
{
  ″name″: ″Invoice belongs to a Customer″,
  ″entities″: {
    ″from″: ″Invoice″,
    ″to″: ″Customer″,
    ″from_key″: ″customer_address″,
    ″to_key″: ″address″
  }
}
‘‘‘
- A function takes entities as input, performs some processing, and then outputs
entities. This is akin to an abstract Python method. Inputs and outputs can be
datastructures that contain entities, such as lists, sets, or dictionaries. In
this case indicate this in the inputs/outputs using Python typing syntax. Make
sure to include a comprehensive description of what the function does and what
calculations it performs. Example of function:
‘‘‘json
{
  ″name″: ″Get total sum of sales to each customer″,
  ″inputs″: [″List[Invoice]″, ″List[Customer]″],
  ″outputs″: [″List[SalesPerCustomer]″],
  ″description″: ″Aggregate all invoice amounts by customer address, then link it
to customers by address, and return a list of SalesPerCustomer objects.″
}
‘‘‘
Make sure to include all entities, relationships, and functions that are relevant
for the task. Together, they should be sufficient to start implementing a Python
program where the functions are methods and the entities are dataclasses.
Do not limit yourself to just the input entities. If you need to create new
entities as intermediate outputs to make the overall system clearer, do so.
Try and make the system as simple as possible, but no simpler. Do not include any
entities, relationships, or functions that are not needed for the task, but make
sure there are entities and functions for all relevant parts of the task.
Always respond with JSON that adheres to the following JSON schema:
‘‘‘
{COMPONENT_ANALYSIS_OUTPUT_JSON_SCHEMA}
‘‘‘
```

The output is the program structure 300, which could be parsed at this point to verify that it conforms to the program schema, prompting corrections and/or feedback to the generator 107 if required.

### 5.4. Function Requirements Mapping

For the subsequent stages, it is useful to map specific requirements to specific functions. A new chat is initiated with the generator 107, in which both the generated program structure 300 and the requirements 110 (in their current state) are given. The generator 107 is asked to produce a requirements mapping (which requirements are satisfied by which functions of the program structure 300) as e.g. a Python dictionary, which can then be parsed programmatically (which in turn may trigger direct modifications to the requirements mapping, or feedback to the generator 107). This is useful to subdivide the problem, and makes it easier to identify any requirements that are not satisfied, etc. As the user progresses through the tool, and there are changes to the requirements and to the program structure, the requirements mapping is updated accordingly.

### 5.5. Generating Additional Function Requirements

The prompt below is used to pass the requirements mapping of the previous section to the generator 107, and ask it to generate any additional function requirements. Note that the requirements have been linked to the program structure 300 at this point, hence the generator performs this task with knowledge of the program structure 300.

```
You are a software engineer.
You are given a function with its inputs and outputs, and a natural language
description of the function.
You are also given a list of requirements that the function must satisfy.
Your job is to generate any additional non-technical requirements that would need
to be added to the list of requirements so that you can unambiguously implement
the function in e.g. a Python application
The input data is provided as JSON in the following example format:
‘‘‘json
{
  ″function″: {
    ″name″: ″Get total sum of sales to each customer″,
    ″inputs″: [″List[Invoice]″, ″List[Customer]″],
    ″outputs″: [″List[SalesPerCustomer]″],
    ″description″: ″Aggregate all invoice amounts by customer address, then link
it to customers by address, and return a list of SalesPerCustomer objects.″
  },
  ″entities″: [
      {
        ″name″: ″Invoice″,
        ″id″: ″str″,
        ″amount″: ″float″,
        ″customer_address″: ″str″,
        ″company_address″: ″str″
      },
      ...
  ],
  ″requirements″: [
      ″The function must return a list of SalesPerCustomer objects.″,
      ″Aggregation should be done by customer address, summing up the amounts of
all invoices for each customer at that address.″,
      ″There should only be one customer per address.″,
      ...
  ]
}
‘‘‘
Output the additional requirements as a list of strings, one per line, in the
following Python list format:
‘‘‘python
[′If a customer has no invoices, the function should return 0 for that customer
address.′, ...]
‘‘‘
```

The output is provided in the form of a structured list, which can then be parsed, in order to add the additional requirements to the requirements document 110 programmatically. Alternatively, the generator 107 could be provided with the requirements document 110 and the additional requirements, and asked to add the additional requirements to the requirements document 110.

### 5.6. Example Requirements

At the end of the requirements discovery process, a complete set of requirements has been generated 100. Prior to submitting the requirements to the synthesis pipeline 104, the structure of the requirements 110 may be modified if appropriate. For example, a requirements graph may be rendered as a document in Markdown format, such as:

# Software Requirements Document
## Introduction
The purpose of this software is to calculate the total overspend per employee
based on the given CSV files with their expenses. The tool will take 6 CSV files
and a date range as input and calculate the
overspend on commuting, food, and office supplies for each employee. The tool will
then output the total overspend for each month in the given date range across all
employees and the top 10
employees that were overspending in this date range.
## Functional Requirements
1. The tool shall take six CSV files as input; read from disk. The user input
should include a date range.
2. The tool shall parse the CSV files and store the data in memory.
3. The tool shall calculate the overspend in the given period on commuting for
each employee by comparing the spend on commuting to the travel records (incl.
mode of transport) for that employee. It should look at the days between
consecutive commuting expense report entries for the same employee, and calculate
the expected cost between them, based on a fixed per-mile cost of 20 cents for car
travel, 15 cents for train travel, and 5 cents for bike travel, and the travel
records for that employee.
4. The tool shall calculate the overspend in the given period on food for each
employee by comparing food spend in the months the period falls in to the
reference monthly spend.
5. The tool shall calculate the overspend in the given period on office supplies
for each employee by comparing office supply spend in the year the period falls in
to the reference yearly spend.
6. The tool shall calculate the total overspend per employee by summing the
overspend on commuting, food, and office supplies.
7. The tool shall calculate the total overspend for each day in the given period
across all vehicles. For food and office supplies per-month spend, it should
normalize the spend in these categories to a per-month spend.
8. The tool shall identify the top 10 employees that were overspending given
period.
9. The tool shall output the total overspend for each month in the given period
across all employees.
10. The tool shall output the top 10 employees that were overspending given
period.
## Non-Functional Requirements
1. The tool shall be written in Python.
2. The tool shall be able to handle large CSV files.
3. The tool shall be able to run on a standard laptop or desktop computer.
4. The tool shall be easy to use and require minimal technical knowledge.
5. The tool shall be well-documented and maintainable.
## Assumptions and Constraints
1. The CSV files will have the same format as described in the introduction.
2. The CSV files will be located in the same directory as the tool.
3. The tool will only calculate overspend for employees that have data in all six
CSV files.
4. The tool will only calculate overspend for the given period.
5. The tool will not handle missing or invalid data in the CSV files.
6. The date range will be specified in months, in format YYYY-MM.
## Output
The tool will output the following:
1. The total overspend for each month in the given period across all employees,
split out to commuting, food, and office supplies.
2. The top 10 employees that were overspending in the given period, with the total
overspend split out to commuting, food, and office supplies.

### 6. Example Code Synthesis Prompts

### 6.1. Technical Design

The following prompt passes a requirements document to the generator 107 and asks it to generate a technical program design. This occurs when the requirements discovery phase has been completed, and the requirements 110 are now complete. The program structure 300 is not passed to the code synthesis pipeline 104 in the following examples. However, in other embodiments, this may be passed to the generator 107 with the requirements document to guide any stage of code synthesis.

You are a software architect.
The user will provide you with a software requirements document.
Output a complete technical design document for the described application
that satisfies all requirements that the
user provided.
The application should be a Python application. The requirements doc will
tell you what kind of application to build, e.g. an API, a web app, a
command line tool, etc.
Only use very commonly used libraries.
Make sure to include sections with:
* All components, their inputs, and outputs, and explicitly which
requirements from the requirements document they satisfy. Copy and paste
the requirements from the requirements document.
* The links between these components
* Storage (if applicable)
* Complete API definitions (if applicable), including input and output
formats
* A description of the data flow
Before finishing, reflect and check that the document is complete and that
all requirements in the requirements document are satisfied and covered in
the technical design document.”””

The output is the technical design 703.

Although the requirements 110 are ‘complete’ at this stage in the sense the requirements discovery phase has completed, they can still be modified, either manually, or a modification to the requirements 110 may be occasioned by a modification to a generated artefact elsewhere in the pipeline (see FIG. 8C). The prompt below asks the generator 107 to update the technical design 703, and the output is a modified version of the technical design 703. This prompt is provided in the same chat. Alternative, a new chat may be initiated, and the generator 107 may be explicitly provided with the relevant context at this point (the technical design 703, the requirements 110, and the modification to the requirements)

If the requirements 110 are updated, the generator 107 may be prompted to update the technical design 703 with a prompt such as:

The user has updated the requirements document with the diff below. Output a new technical design document that satisfies all requirements in the new requirements document.

### 6.2. Generating Software Skeleton

The prompt below generates a backend skeleton file structure with all the boilerplate code and core interfaces for the given application. The output is the software skeleton 705.

You are a staff software engineer.
The user will provide you with a technical design document for an application.
Output a skeleton Python application according to this design document. It does
not need to contain all code, but it should have all the files, and boilerplate
methods/classes for everything. You do not need to include tests.
Make sure any filepaths are output in full.
Make sure all function parameters have the correct type annotations.
Make sure all functions have a docstring describing what they do and if there are
any data calculations or transformations, how they are performed.
Use the following Markdown output template:
# File structure
folder/file1.py
folder/file2.py
anotherfolder/file.py
...
# Files
## File 1: ‘folder/file.py‘
‘‘‘
<CONTENTS OF FILE.PY>
‘‘‘
# Dependencies
‘‘‘
pip install <PACKAGE_NAMES>
‘‘‘

### 6.3. Test Generation

The prompt below is used to generate tests from the requirements 110 and the software skeleton 300.

You are a staff software engineer.
The user will provide you with a requirements document and technical design
document for a particular Python backend application, and skeleton code for this
application.
Output comprehensive unit-, component-level, and API-level tests that test all
relevant requirements for this application.
Make sure all functions in the code are covered by test cases and that all test
methods start with ‘test_‘.
Input will be given in the following Markdown input template:
‘‘‘
# Requirements Document
<DOCUMENT>
# Technical design document
<DOCUMENT>
# File structure
<FILE STRUCTURE>
# Files
## File 1: ‘file.py‘
<CONTENTS OF FILE.PY>
‘‘‘
Provide your tests in the following Markdown format:
‘‘‘
# File 1: ‘test_component_x.py‘
<CONTENTS OF test_component_x.py>
# File 2: ‘test_component_y.py‘
<CONTENTS OF test_component_y.py>
# File 3: ‘test_api.py‘
<CONTENTS OF test_api.py>
‘‘‘
If any of the tests requires any files with test data, also output these in the
above format.

### 6.4. Code Generation

The prompt below is used to generate code for the application 112, given the requirements 110, the technical design 703 and the skeleton 705. This prompt is also used to generate code for each text. Code is generated for program and test files individually (each file is passed in a separate prompt). Note, however, that the context of the other code files is provided as part of the software skeleton 705. This means that, although code is generated individually per-file, the prompts still contain all necessary context about interfaces in other files.

You are a staff software engineer.
It is your task to write a single file of code that is part of a larger
software project. The file already has boilerplate code that provides the
structure, but most methods are not filled out.
Make sure all function parameters have the correct type annotations.
Make sure that for any data structures, the type of each field is
specified by using typed data classes or similar.
The user will provide you with all information about the project in the
following Markdown format:
--- TEMPLATE START
# Requirements Document
<SOFTWARE REQUIREMENTS DOCUMENT>
# Technical design document
<TECHNICAL DESIGN DOCUMENT>
# Skeleton document
<SKELETON OF THE SOFTWARE WITH ALL FILES AND BOILERPLATE CONTENT>
# Code to complete: ‘ <FILENAME>‘
‘‘‘python
<SKELETON CODE FOR THE FILE TO COMPLETE>
‘‘‘
--- TEMPLATE END
Output full working code for the file you're asked to complete. Output only the
code in Markdown format and NOTHING else.

### 6.5. “FIXME” Edits

FIXME edits in the code can be actions using the following prompt to the generator 107. As described above, users can put “FIXME”s in the generated code. This prompt picks up on them and then describes how to fix them.

You are a staff software engineer. You will be given a technical design document,
a software implementation and a file with a set of [FIXME] comments in it.
Your goal is to look at the [FIXME] comments and write a few sentences to explain
what the issue is that needs to be fixed and tell me which files should be fixed.
You will need this as a hint when you try again later. Only provide the few
sentence description in your answer, not the implementation.
Output your answer in the following Markdown format:
‘‘‘
# Reflection
<YOUR REFLECTION>
# Files to fix
- ‘<FILE 1>‘
- ‘<FILE 2>‘
- ‘<FILE 3>‘
...
‘‘‘

The answer can then be fed back to the generator 107 itself, instructed to operate in the software engineer role, and modify the code to implement the fixes. Specifically, if this outputs a reflection and files A,B,C, a version of the code generation prompt would be provided for each file A,B,C with this reflection. In other words, the platform 100 is essentially asking the model “it's not working, here's a reflection of the test output, here's file A, fix it”, then “it's not working, here's a reflection of the test output, here's file B, fix it”, etc. This forces the generator 107 to consider every required fix.

### 7. Example Static Analysis

Example forms of static analysis applied to generated code artefacts are described in more detail below.

### 7.1. Check for Tests

A simple test is a check that a test file actually contains a test. Note the previous instruction to the generator 107 when generating the tests: “Make sure all functions in the code are covered by test cases and that all test methods start with ‘test’. Having specified this naming convention, the check for the presence of a test can be performed programmatically, by parsing generated test code, in the following manner:

```
# Description: Check if code contains a test
def _contains_test(code: str) −> bool:
  try:
    parsed_ast = ast.parse(code)
    # Get a list of all methods and class methods in the file
    functions = [
      node
      for node in ast.walk(parsed_ast)
      if isinstance(node, (ast.FunctionDef, ast.AsyncFunctionDef))
    ]
    # Check at least one of them starts with “test”
    return any(function.name.startswith(“test”) for function in functions)
  except SyntaxError:
    raise ValueError(“Expected valid Python code only, but syntax is
invalid.”)
```

The “_contains_test” algorithm can be applied to all generated test files.

If an error is returned, a prompt is automatically submitted to the generator 107:

if not _contains_test(model_output):
RetryWithPrompt(“Please make sure the code contains at least one unit test.”)

Hence, the output of a static analysis is used to automatically prompt the generator 107 to modify a generated code artefact.

### 7.2. Missing Dependencies

A check for missing dependencies in generated code can be implemented programmatically in the following manner:

```
###############################
# Main code
###############################
async def add_missing_dependencies(
  program_dir: Path,
) −> list[str]:
  analyzer = DependencyAnalyzer(program_dir)
  imports_with_unknown_deps = analyzer.imports_with_unknown_dependency
  missing_deps = analyzer.undeclared_external_dependencies
  # If we have unknown deps, ask the model to map them to pypi packages
  if imports_with_unknown_deps:
    input_doc = f″″″
      # Modules with unknown package dependencies
      ‘‘‘
      {str(imports_with_unknown_deps))}
      ‘‘‘
    ″″″
    response = await AskLLM(
      prompt=<SEE_PROMPT_BELOW>,
      input=input_doc,
    )
    response = dependency_response_to_python_list(response)
    missing_deps.extend(response)
  return missing_deps
###############################
# Dependency analyzer
# Uses the ‘fawltydeps‘ library to find missing dependencies.
###############################
import ast
from importlib import resources
from pathlib import Path
import json
import fawltydeps.main as fd
class DependencyAnalyzer:
  def _{——}init_{——}(self, project_dir: Path):
    self.project_dir = project_dir
  def _analyze_undeclared_external_dependencies(self) −> tuple[list[str],
list[str]]:
    # Use fawltydeps to find missing dependencies.
    # If not, ask the model to map them to pypi packages.
    # Returns both the missing dependencies and the imports that we don't know
    # how to map.
    manual_mapping_file = json.load(Path(‘manual_mappings.json’)
    import_to_package = { }
    for package_name, imports in manual_mapping.items( ):
      for import_name in imports:
        import_to_package[import_name] = package_name
    # Run fawltydeps
    settings = fd.Settings(
      actions={fd.Action.REPORT_UNDECLARED},
      output_format=fd.OutputFormat.JSON,
      code={self.project_dir},
      deps={self.project_dir / ″requirements.txt″},
      custom_mapping_file={manual_mapping_file},
    )
    analysis = fd.Analysis.create(settings)
    imports_with_missing_deps = [dep.name for dep in analysis.undeclared_deps]
    # Check if for any of our missing deps we have a manual mapping
    missing_deps = [ ]
    imports_with_unknown_deps = [ ]
    for import_name in imports_with_missing_deps:
      if import_name in import_to_package:
        missing_deps.append(import_to_package[import_name])
      else:
        imports_with_unknown_deps.append(import_name)
    return missing_deps, imports_with_unknown_deps
  def undeclared_external_dependencies(self) −> list[str]:
    return self._analyze_undeclared_external_dependencies( )[0]
  def imports_with_unknown_dependency(self) −> list[str]:
    return self._analyze_undeclared_external_dependencies( )[1]
```

In some cases, it may be possible to resolve missing dependencies programmatically through direct modification to the code, without requiring any feedback to the generator 107. However, sometimes it is not possible to resolve certain missing dependencies programmatically, in which case the generator 107 may be prompted to do so:

You are a staff software engineer. The user will provide you with a list of Python
module imports for which the pip package dependencies are missing. You will need
to add the missing dependencies to the pip installation command. If for a given
module import, you're not sure or you think this is a local module, ignore it.
The user will provide you with the modules:
--- TEMPLATE START
# Modules with unknown package dependencies
‘‘‘
<MODULE 1>
<MODULE 2>
...
‘‘‘
--- TEMPLATE END
Output a list of all missing dependencies. Output it in a code block.″″″

This prompt causes the generator 107 to generate a list of all missing dependencies for a given list of module imports pip package dependencies that could not be found programmatically.

When referring to the platform 100 itself, ‘components’ of the platform generally refer to functionality implemented within the platform 100 (i.e. functional components of the platform), such as the requirements discovery pipeline 102 or the code synthesis pipeline 104, or some individual component corresponding to particular functionality described herein. When used in this context, the term ‘components’ does not imply any particular structure or system architecture, unless otherwise indicated. Such components are typically implemented in software, which is to say computer-readable instructions executed on one or more hardware processors. A computer system refers to a computer or set of networked computers, where the/each computer comprises one or more hardware processors. A hardware processor may take the form of a central processing unit (CPU), graphical processing unit (GPU) or other accelerator processors. Such processors are so-called ‘general purpose’ processors that may be programmed. Alternatively or in addition other forms of programmable hardware processor, such as field-programmable gate arrays (FPGAs), may be used. Non-programmable hardware processors, such as application-specific integrated circuits (ASICs) may be used. Computer-readable instructions may be stored in non-transitory media (such as magnetic or solid-state storage).

Note that, in the context of code generation (particularly component-level code generation and testing), the term ‘component’ has the meaning set out above.

In one aspect herein, a computer system is provided for synthesising computer program code based on program design artefacts, the computer system comprising: a code synthesis component configured to create at least one code synthesis prompt based on a program design artefact, and obtain synthesised program code by submitting the at least one code synthesis prompt to a machine learning (ML)-based generator; and a program design component configured to obtain the program design artefact for synthesizing the first program code by submitting at least one program design prompt to the ML-based generator; wherein responsive to a first instruction to modify the synthesised program code, the code synthesis component is configured to modify the synthesised program code, resulting in modified program code, wherein the program design component is configured to submit at least one design update prompt to the ML-based generator based on the modified program code, causing the ML-based generator to generate an updated program design item; or wherein responsive to a second instruction to modify the program design artefact, the program design component is configured to modify the program design artefact, resulting in a modified design artefact, wherein the code synthesis component is configured to submit at least one code update prompt to the ML-based generator based on the modified design artefact, causing the ML-based generator to generate updated program code.

In embodiments, the computer system may comprise a user interface, wherein the first instruction or the second instruction are user initiated via the user interface.

The code synthesis component may be configured to store the synthesised program code in a version control repository, wherein the program design component may be configured to store the program design artefact in the version control repository, wherein the modified or updated program code and the modified or updated program design artefact may be stored in the version control repository, and the synthesised program code and the design item may be retained in the version control repository.

The version control repository may be a Git repository.

The version control repository may be accessible via the user interface to enable user-initiated modification of the synthesised program code or the design item stored in the version control repository.

In the case the first instruction to modify the synthesised program code is received, the modified program code may include a modification marker inserted based on the first instruction. The code synthesis component may be configured to submit to the ML-based generator at least one code update prompt to cause the ML-based generator to generate updated program code based on the modified program code and the updated design artefact.

The above user interface may be configured to render a code editor interface to enable a user to review the synthesised program code and insert the modification marker in the synthesised program code.

The modification marker may be inserted in the form of a comment.

The program design artefact may, for example, be a set of software requirements, a technical design, or a software skeleton, or a code artefact.

Another aspect herein provides a computer system for synthesising a software application based on program design artefacts, the computer system comprising: a code synthesis component configured to create at least one code synthesis prompt based on a program design artefact, and obtain a first code component for the software application and a second code component for the software application by submitting the at least code synthesis prompt to a machine learning (ML)-based generator; wherein, responsive to a modification instruction, the code synthesis pipeline is configured to modify the first code component, resulting in a modified first code component; wherein the code synthesis component is configured to submit at least one code modification prompt to the ML-based generator to cause the ML-based generator to generate an updated second code component based on the second code component and the modified first code component.

In embodiments, the code synthesis component may be configured to cause the ML-based generator to generate an updated first code component based on the modified first code component, and the second code component may be generated based on the updated first code component.

The modified first code component may include a modification marker inserted based on the modification instruction.

The computer system may comprise a user interface, and the modification instruction may be received via the user interface.

The user interface may be configured to render a code editor interface to enable a user to review the synthesised program code and insert the modification marker in the synthesised program code.

The computer system may be configured to store the first code component, the second code component, the modified first code component and the updated second code component in a version control repository.

The code synthesis component may be configured to cause the ML-based generator to generate: the first code component by submitting at least one first code synthesis prompt, and the second code component by submitting at least one second code synthesis prompt.

The at least one first code synthesis prompt may be submitted in a first communication session with the ML-based generator, and the at least one second code synthesis prompt may be provided in a second communication session with the ML-based generator.

To generate the first code component and the second code component, the ML-based generator may be provided with at least one program design artefact indicating a relationship between the first code component and the second code component.

For example, the at least one program design artefact may comprise a technical design for the software application, or a software skeleton for the application.

Another aspect herein provides a computer system for synthesising computer program code based on program design artefacts, the computer system comprising: a code synthesis component configured to create at least one code synthesis prompt based on a program design artefact, and obtain synthesised program code by submitting the at least one code synthesis prompt to a machine learning (ML)-based generator; and a user interface; wherein, responsive to a modification instruction received via the user interface, the code synthesis component is configured to insert a modification marker in the synthesised program code, resulting in modified program code comprising the modification marker, and submit a code update prompt to the ML-based generator to cause the ML-based generator to generate updated program code based on the modified program code.

Another aspect herein provides a computer system for synthesising computer program code, the computer system comprising: a requirements discovery component configured to receive a description of a software application to be synthesised, and cause a machine learning (ML)-based generator to perform the following operations, by submitting a series of prompts to the ML-based generator: generate, based on the description, an initial set of requirements for the software application, generate based on the initial set of requirements an initial program structure for the software application, generate, based on the initial set of requirements and the initial program structure, an updated set of requirements for the software application; a code synthesis component configured to receive the updated set of requirements, and cause the ML-based generator to generate program code for the software application based on the modified set of requirements.

In embodiments, the requirements discovery component may be configured to indicate a requirements structure to the ML-based generator.

The requirements discovery component may be configured to: parse each set of requirements to determine whether it confirms with the indicated requirements structure, and if not, correct the set of requirements or prompt the ML-based generator to correct the set of requirements.

The requirements discovery component may be configured to indicate a program structure schema to the ML-based generator.

The requirements discovery component may be configured to: parse the program structure to determine whether it confirms with the indicated program structure schema, and if not, correct the program structure or prompt the ML-based generator to correct the program structure.

The computer system may comprise a user interface configured to receive the description from a user.

The user interface may be configured to output the updated set of requirements to the user, and receive a feedback input pertaining to an individual requirement of the set of requirements. The requirements discovery component may be configured to prompt the ML-based generator to: modify the individual requirement according to the feedback input, and determine whether any other changes to the set of requirements is required, for example updating another requirement(s), removing another requirement(s), or adding another requirement(s).

The user interface may be configured to render a chat interface, in which the feedback input is provided by the user.

The description may include one or more responses to one or more questions, the user interface configured to output the questions to the user and receive the responses from the user.

For example, each question may be predetermined, or generated by the ML-based generator.

The requirements discovery component may be configured to identify one or more functions within the program structure, and for each function, determine a mapping between each function and one or more individual requirements of the initial set of requirements. The updated set of requirements may be generated based on the determined mapping.

The requirements discovery component may be configured to use the ML-based generator to determine the mapping.

Another aspect provides a computer system for synthesising a software application, the computer system comprising: one or more processors configured to cause a machine learning (ML)-based generator to perform the following operations, by submitting a series of prompts to the ML-based generator: generate a technical design for the software application based on a set of software requirements; generate a software skeleton for the application based on the technical design; and generate program code for the application based on the software skeleton.

The software skeleton may indicate multiple program elements, and the ML-based generator may be caused to generate respective program code for the multiple program elements individually.

The software skeleton may, for example, include boilerplate code that provides a structure for the software application.

The respective program code may be generated for the multiple program elements in separate communication sessions with the ML-based generator (each with separate context/history).

The technical design and the software skeleton may be generated in separate communication sessions with the ML-based generator, and with the ML-based generator instructed to operate in different roles.

The above operations may further comprise generating at least one test for the software application based on the software skeleton, generating test program code for the at least one software test.

Multiple tests may be generated, the multiple tests comprising at least one test for each program element, and respective test program code may be generated for the multiple tests individually.

Each program element may, for example, be a program file.

The computer system may be configured to run each test and provide feedback on at least one test outcome to the ML-based generator.

The computer system may be configured to perform an analysis of the technical design, the software skeleton or the program code, and provide feedback to the ML-based generator based on the analysis, resulting in an update to the technical design, software skeleton or program code.

1. A computer system for synthesising computer program code, the computer system comprising:
a code synthesis component configured to receive an input, and cause a machine learning (ML)-based generator to generate an initial code artefact based on the input by submitting at least one prompt to the ML-based generator;
a static analysis component configured to identify an error in the initial code artefact by applying a static analysis to the initial code artefact; and
a feedback component configured to indicate the identified error to the ML-based generator in at least one further prompt, causing the ML-based generator to generate an updated code artefact in response to the identified error.

2. The computer system of claim 1, wherein a second error is identified in the initial code artefact by applying the static analysis, wherein the static analysis is configured to correct the identified second error programmatically, without feedback to the ML-based generator.

3. The computer system of claim 1, wherein the code artefact describes a software test, and the identified error is that no test method is contained in the code artefact.

4. The computer system of claim 1, wherein the identified error is a software dependency error, wherein in performing the static analysis, the code synthesis component attempts to correct the error programmatically, wherein the identified error is indicated to the ML-based generator in response to the code synthesis component failing to correct the error.

5. The computer system of claim 4, wherein a second error is identified in the initial code artefact by applying the static analysis, wherein the static analysis is configured to correct the identified second error programmatically, without feedback to the ML-based generator; and
wherein the second identified error is a second software dependency error.

6. The computer system of claim 1, wherein the updated code artefact is generated by indicating the error to the ML-based generator, instructing it to generate a reflection based on the error, and instructing it to generate the updated code based on the reflection.

7. The computer system of claim 6, wherein the ML-based generator is instructed to generate the reflection in natural language.

8. The computer system of claim 1, wherein the input comprises a program design artefact or another code artefact.

9. A computer-implemented method of synthesising computer program code, the method comprising:
receiving an input;
generating, using a machine learning (ML)-based generator, an initial code artefact based on the input by submitting at least one prompt to the ML-based generator; and
identifying an error in the initial code artefact by applying a static analysis to the initial code artefact indicating the identified error to the ML-based generator in at least one further prompt, causing the ML-based generator to generate an updated code artefact in response to the identified error.

10. The method of claim 9, wherein a second error is identified in the initial code artefact by applying the static analysis, wherein the static analysis is configured to correct the identified second error programmatically, without feedback to the ML-based generator.

11. The method of claim 9, wherein the program artefact describes a software test, and the identified error is that no test method is contained in the code artefact.

12. The method of claim 9, wherein the identified error is a software dependency error, wherein in performing the static analysis, the code synthesis component attempts to correct the error programmatically, wherein the identified error is indicated to the ML-based generator in response to the code synthesis component failing to correct the error.

13. The method of claim 10, wherein the identified error is a software dependency error, wherein in performing the static analysis, the code synthesis component attempts to correct the error programmatically, wherein the identified error is indicated to the ML-based generator in response to the code synthesis component failing to correct the error; and
wherein the second identified error is a second software dependency error.

14. The method of claim 9, wherein the updated code artefact is generated by indicating the error to the ML-based generator, instructing it to generate a reflection based on the error, and instructing it to generate the updated code based on the reflection.

15. The method of claim 14, wherein the ML-based generator is instructed to generate the reflection in natural language.

16. The method of claim 9, wherein the input comprises a program design artefact or another code artefact.

17. A non-transitory computer readable medium embodying computer program instructions, the computer program instructions configured so as, when executed on one or more hardware processors, to implement operations comprising:
receiving an input;
generating, using a machine learning (ML)-based generator, an initial code artefact based on the input by submitting at least one prompt to the ML-based generator; and
identifying an error in the initial code artefact by applying a static analysis to the initial code artefact indicating the identified error to the ML-based generator in at least one further prompt, causing the ML-based generator to generate an updated code artefact in response to the identified error.
